(19) United States
(12) Patent Application Publication
(10) Pub. No.: US 2010/0107174 A1
(43) Pub. Date: Apr. 29, 2010

(54) SCHEDULER, PROCESSOR SYSTEM, AND PROGRAM GENERATION METHOD

(75) Inventors: Takahisa SUZUKI, Kawasaki (JP); Makiko Ito, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/606,837

(22) Filed: Oct. 27, 2009

(30) Foreign Application Priority Data
Oct. 29, 2008 (JP) 2008-278352

(51) Int. Cl. G06F 9/50

(52) U.S. Cl. 718/104

(57) ABSTRACT

A scheduler for conducting scheduling for a processor system including a plurality of processor cores and a plurality of memories respectively corresponding to the plurality of processor cores includes: a scheduling section that allocates one of the plurality of processor cores to one of a plurality of process requests corresponding to a process group based on rule information; and a rule changing section that, when a first processor core is allocated to a first process of the process group, changes the rule information and allocates the first processor core to a subsequent process of the process group, and that restores the rule information when a second processor core is allocated to a final process of the process group.

### CROSS-REFERENCE TO RELATED APPLICATIONS

This application claims the benefit of priority from Japanese Patent Application No. 2008-278352 filed on Oct. 29, 2008, the entire contents of which are incorporated herein by reference.

### BACKGROUND

1. Field

Embodiments of embodiments discussed herein relate to scheduling of processor systems.

2. Description of Related Art

Techniques related to a multicore processor system are disclosed in Japanese Laid-Open Patent Publication No. 2007-133858, Japanese Laid-Open Patent Publication No. 2006-293768, Japanese Laid-Open Patent Publication No. 2003-30042, and Japanese Laid-Open Patent Publication No. 2004-62910, for example.

### SUMMARY

According to one aspect of the embodiments, a scheduler for conducting scheduling for a processor system including a plurality of processor cores and a plurality of memories respectively corresponding to the plurality of processor cores is provided. The scheduler includes a scheduling section that allocates one of the plurality of processor cores to one of a plurality of process requests corresponding to a process group based on rule information; and a rule changing section that, when a first processor core is allocated to a first process of the process group, changes the rule information and allocates the first processor core to a subsequent process of the process group, and that restores the rule information when a second processor core is allocated to a final process of the process group.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates a first embodiment.

FIG. 2 illustrates exemplary scheduling rules.

FIG. 3 illustrates an exemplary operation of a rule changing section.

FIG. 4 illustrates an exemplary operation of a rule changing section.

FIG. 5 illustrates an exemplary operation of a rule changing section.

FIG. 6 illustrates an exemplary application.

FIG. 7 illustrates exemplary scheduling rules.

FIG. 8 illustrates an exemplary control program.

FIG. 9 illustrates an exemplary scheduler.

FIG. 10 illustrates an exemplary scheduler.

FIG. 11 illustrates an exemplary scheduler.

FIG. 12 illustrates an exemplary scheduler.

FIG. 13 illustrates an exemplary scheduler.

FIG. 14 illustrates an exemplary the scheduler.

FIG. 15 illustrates an exemplary the scheduler.

FIG. 16 illustrates an exemplary the scheduler.

FIG. 17 illustrates an exemplary method for dealing with conditional branching.

FIG. 18 illustrates another exemplary an application.

FIG. 19 illustrates exemplary scheduling rules.

FIG. 20 illustrates exemplary scheduling rule changes.

FIG. 21 illustrates exemplary scheduling rules.

FIG. 22 illustrates exemplary scheduling rule changes.

FIG. 23 illustrates exemplary scheduling rules.

FIG. 24 illustrates exemplary scheduling rule restoration.

FIG. 25 illustrates an exemplary parallelizing compiler.

FIG. 26 illustrates an exemplary execution environment for a parallelizing compiler.

FIG. 27 illustrates an exemplary scheduling policy optimization process.

FIG. 28 illustrates an exemplary grouping target graph extraction process.

FIG. 29 illustrates an exemplary scheduling policy optimization process.

FIG. 30 illustrates an exemplary processor system.

FIG. 31 illustrates exemplary scheduling rules.

### DESCRIPTION OF EMBODIMENTS

In a built-in processor system, the operating frequency thereof may not be increased due to increases in power consumption, physical limitation, etc., and therefore, parallel processing of a plurality of processor cores, for example, is performed. In the parallel processing of the plurality of processor cores, synchronization between processor cores and/or communication overhead occurs. Therefore, a program is divided into units, each of which is greater than an instruction, and a plurality of processes, for example, processes divided into N processes, are executed simultaneously by a plurality of processor cores, for example, M processor cores.

The number N of processes may be greater than the number M of processor cores, and processing time may be different for each process. Processing time may be changed in accordance with processing target data. Therefore, a multicore processor system, in which parallel processing is performed by a plurality of processor cores, includes a scheduler for deciding which processes are allocated to which processor cores in which order. Schedulers are classified into static schedulers and dynamic schedulers. A static scheduler estimates processing time to decide optimum allocation in advance. A dynamic scheduler decides allocation at the time of processing.

A dynamic scheduler includes homogeneous processor cores (e.g., a homogeneous multicore processor system). As for a built-in multicore processor system, it is desirable that the system be constructed with the minimum resources required. Therefore, in accordance with processing characteristics, Reduced Instruction Set Computer (RISC), Very Long Instruction Word (VLIW), and Digital Signal Processor (DSP) processors are combined with each other (e.g., a heterogeneous configuration). Hence, in a multicore processor system having a heterogeneous configuration, dynamic scheduling is preferably carried out.

In a multicore processor system, a plurality of processor cores may have a single memory. A plurality of processor cores may be unable to access to a memory contemporaneously. Therefore, each processor core may independently have a memory.

In a multicore processor system having a heterogeneous configuration, a multigrain parallelizing compiler may generate a scheduling code for dynamic scheduling. Further, an input program may control a processor core, and furthermore, a processor core may perform scheduling.

If each processor core independently has a memory, which processor core executes a process is decided at the time of process execution in dynamic scheduling. Therefore, for example, if a processor core C executes a process P, data used in the process P may be stored in the memory of the processor core C.

For example, if data generated in a process Pa is used in another process Pb, the process Pa is allocated to a processor core Ca and the process Pb is allocated to another processor core Cb, and data generated in the process Pa is preferably transferred from the memory of the processor core Ca to the memory of the processor core Cb. For example, if the processes Pa and Pb are allocated to the same processor core, data transfer between the processes Pa and Pb becomes unnecessary, and the process Pb may be efficiently executed.

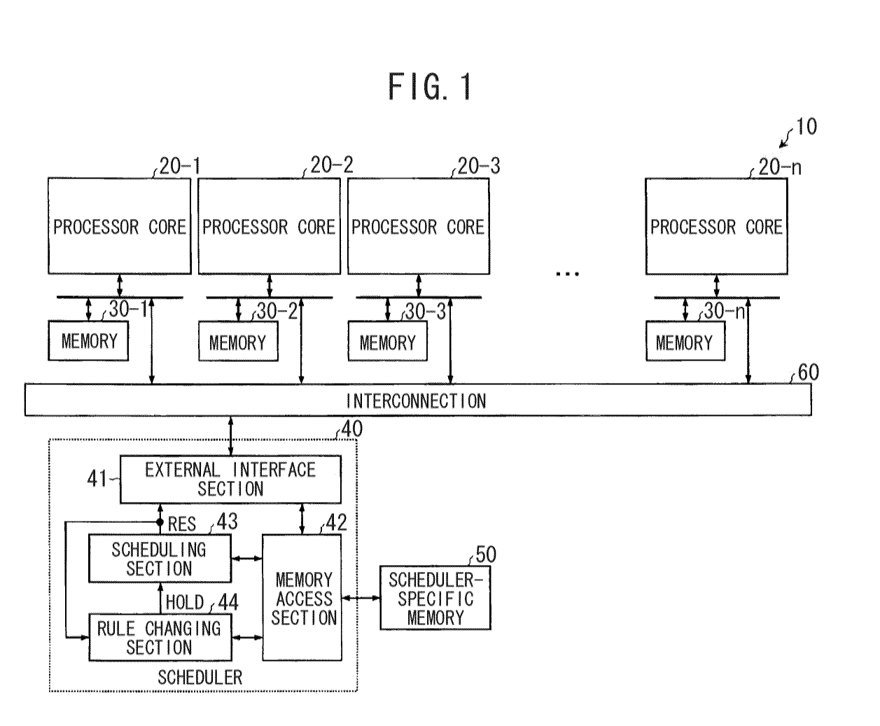

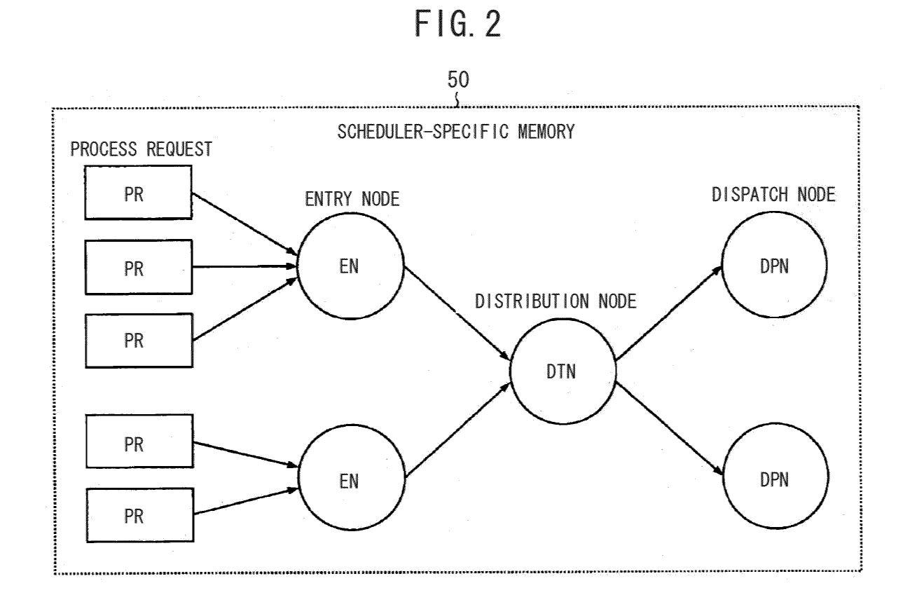

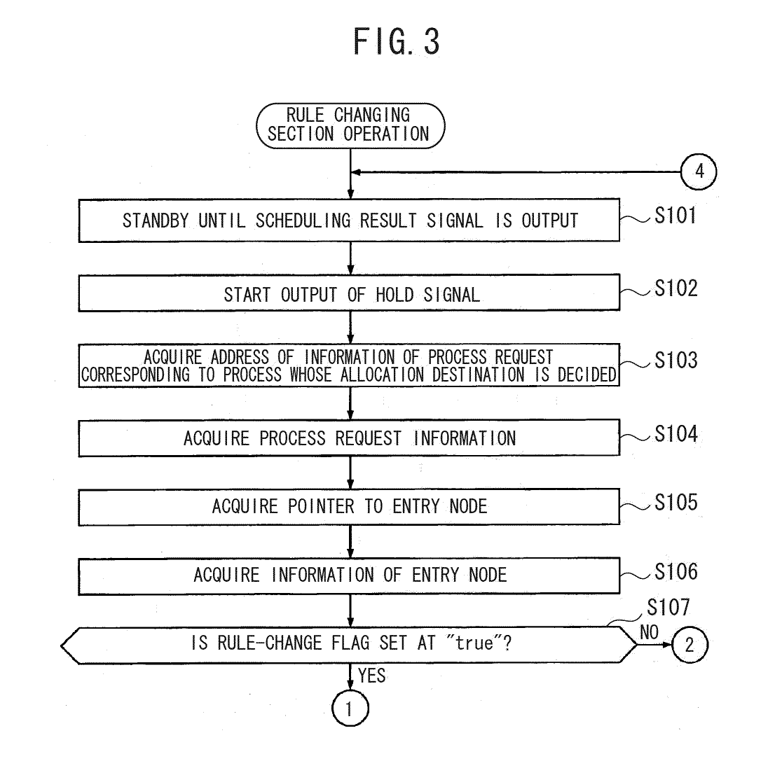

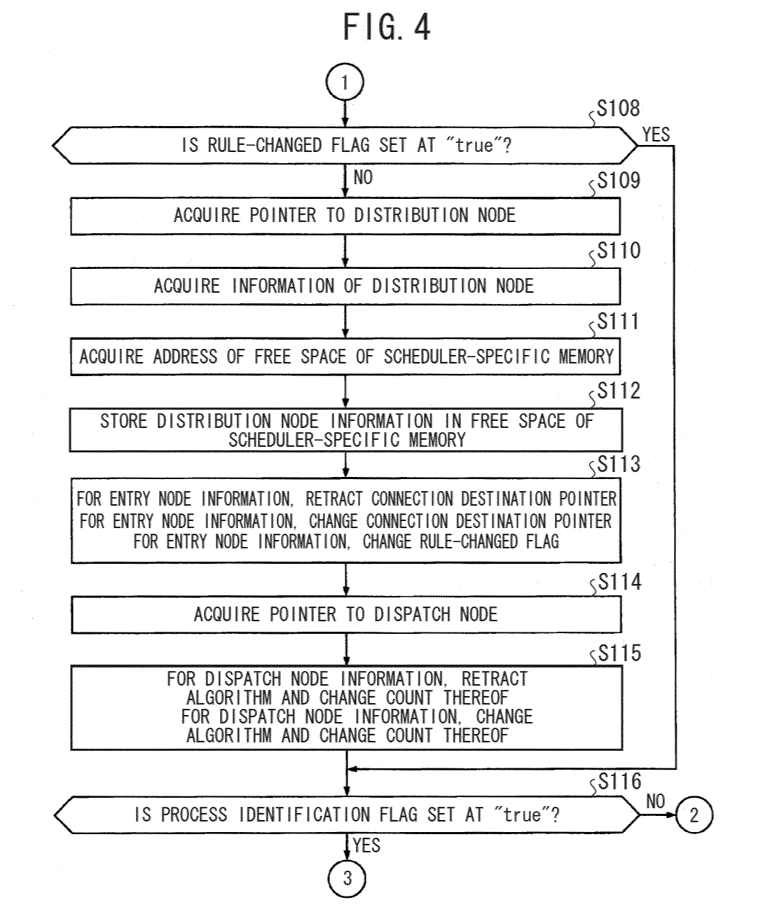

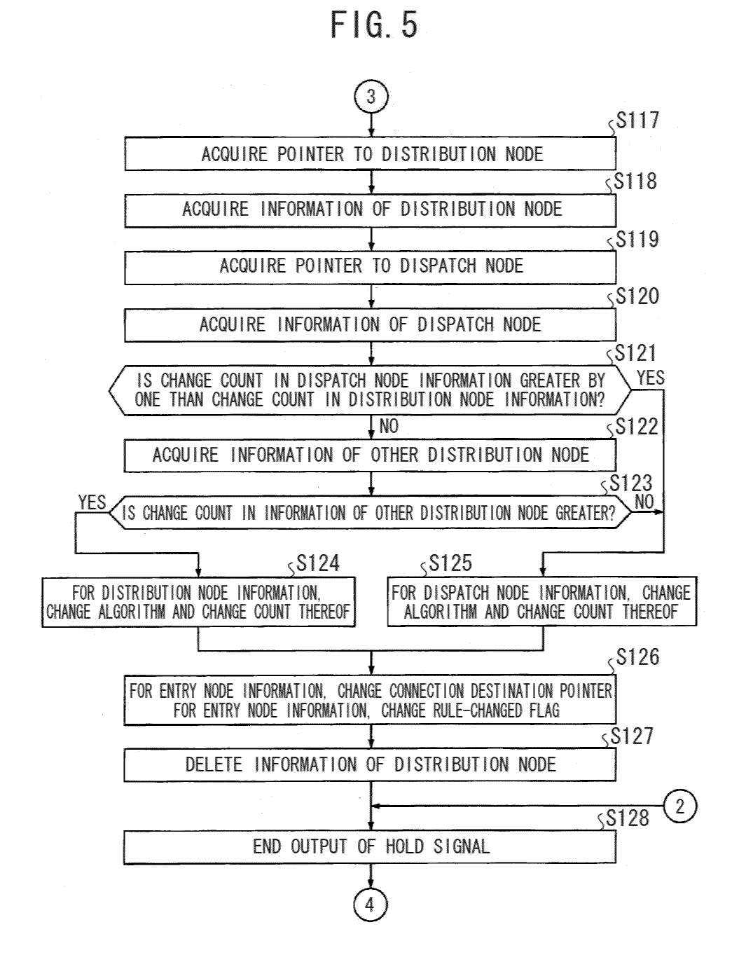

FIG. 1 illustrates a first embodiment. FIG. 2 illustrates exemplary scheduling rules. FIG. 1 illustrates a processor system 10. The processor system 10 may be a distributed memory type heterogeneous multicore processor system. The processor system 10 includes: processor cores 20-1 to 20-n; memories 30-1 to 30-n; a scheduler 40; a scheduler-specific memory 50; and an interconnection 60. FIGS. 3 to 5 each illustrate exemplary operations of a rule changing section. The rule changing section may be a rule changing section 44 illustrated in FIG. 1.

The processor core 20-k (k=1, 2, 3 . . . , n) executes a process allocated by the scheduler 40 while accessing to the memory 30-k. The memory 30-k stores data used by the processor core 20-k, data generated by the processor core 20-k, etc. The scheduler 40 performs dynamic scheduling, e.g., dynamic load balancing scheduling, for the processor cores 20-1 to 20-n while accessing the scheduler-specific memory 50. The scheduler-specific memory 50 stores information including scheduling rules or the like which are used in the scheduler 40. The interconnection 60 interconnects the processor cores 20-1 to 20-n, the memories 30-1 to 30-n and the scheduler 40 to each other for reception and transmission of signals and/or data.

As illustrated in FIG. 2, for example, the scheduling rules are illustrated using entry nodes (EN), dispatch nodes (DPN), and a distribution node (DTN). A plurality of distribution nodes may be provided.

Each entry node corresponds to an entrance of the scheduler 40, and a process request (PR) corresponding to a requested process is coupled to each entry node. Each dispatch node corresponds to an exit of the scheduler 40, and corresponds to a single processor core. The distribution node associates the entry nodes with the dispatch nodes. Each entry node retains information of a scheduling algorithm for process request selection. The distribution node retains information of a scheduling algorithm for entry node selection. Each dispatch node retains information of a scheduling algorithm for distribution node selection. Each dispatch node further retains information of an operating state of the corresponding processor core, and information of a process to be executed by the corresponding processor core.

In the scheduler 40, for each entry node, one of the process requests coupled to the entry node is selected based on the information of the scheduling algorithm for process request selection. For each distribution node, one of the entry nodes coupled to the distribution node is selected based on the information of the scheduling algorithm for entry node selection. Based on the information of the scheduling algorithm for distribution node selection, the information of the operating state of the corresponding processor core, etc. in each dispatch node, a process corresponding to the process request selected by the distribution node, for example, a determination of the dispatch node such as the processor core, to which a process corresponding to the process request selected by the entry node is allocated, is performed.

Information on the process requests, entry nodes, distribution node, and dispatch nodes is stored, as list structure data, in the scheduler-specific memory 50. The scheduling rules used in the scheduler 40 are freely changed in accordance with an application. Therefore, various applications may be applied without changing a circuit of the scheduler 40. The scheduling rules may be changed in accordance with a change in the state of the processor system 10 during execution of an application in the processor system 10.

The scheduler 40 includes: an external interface section 41; a memory access section 42; and a scheduling section 43. The external interface section 41 communicates with the outside of the scheduler 40, e.g., the processor cores 20-1 to 20-n and the like, via the interconnection 60. The memory access section 42 accesses the scheduler-specific memory 50. The scheduling section 43 carries out dynamic load balancing scheduling. Operations of the processor system 10 include scheduling rule construction, process request registration, process end notification, scheduling result notification, etc.

For example, when the processor system 10 is started up and/or when the scheduling rules are changed due to a change in the state of the processor system 10, scheduling rule construction is carried out. Information of the scheduling rules retained in advance in the processor system 10 is stored in the scheduler-specific memory 50 via the external interface section 41 and the memory access section 42 by a device provided outside of the scheduler 40 such as a front-end processor core or a loading device. The scheduling rules stored in the scheduler-specific memory 50 are used in the dynamic load balancing scheduling of the scheduling section 43.

For example, when a new process is generated for a process of a processor core provided outside of the scheduler 40, process request registration is carried out. Process request information is stored in the scheduler-specific memory 50 via the external interface section 41 and the memory access section 42. In this case, an entry node of a connection destination for a process request is designated by an application. Thereafter, the scheduling section 43 carries out dynamic load balancing scheduling.

For example, when a process allocated to a processor core 20-x is ended, process end notification is carried out. Processor core operating state information for the dispatch node corresponding to the processor core 20-x in the scheduler-specific memory 50 is updated via the external interface section 41 and the memory access section 42 by the processor core 20-x. Thereafter, the scheduling section 43 carries out dynamic load balancing scheduling.

For example, when the process of the processor core 20-x is changed due to the scheduling result of the scheduling section 43, scheduling result notification is carried out. The scheduling section 43 notifies the processor core 20-x of the process change via the external interface section 41.

The scheduler 40 includes the rule changing section 44. The rule changing section 44 changes and restores the scheduling rules constructed by the scheduler-specific memory 50. When the scheduling section 43 performs processor core allocation for the first process of a process group decided in advance, the rule changing section 44 changes the scheduling rules, and allows the scheduling section 43 to allocate the subsequent process of the process group to the same processor core as that to which the first process is allocated. When the scheduling section 43 performs processor core allocation for the final process of the process group, the rule changing section 44 restores the scheduling rules.

FIGS. 3 to 5 each illustrate exemplary operations of a rule changing section. In Operation S101, the rule changing section 44 is put on standby until a scheduling result signal RES is output from the scheduling section 43 to the external interface section 41. When the scheduling result signal RES is output from the scheduling section 43, the process goes to Operation S102.

In Operation S102, the rule changing section 44 outputs a hold signal HOLD to the scheduling section 43, and therefore, the scheduling section 43 stops its operation. Then, the process goes to Operation S103.

In Operation S103, the rule changing section 44 acquires, out of the scheduling result signal RES, an address of the scheduler-specific memory 50 corresponding to process request information. The process request information indicates that the scheduling section 43 has allocated a processor core. Then, the process goes to Operation S104.

In Operation S104, the rule changing section 44 acquires, via the memory access section 42, process request information for the address acquired in Operation S103. Then, the process goes to Operation S105.

In Operation S105, the rule changing section 44 acquires, out of the process request information acquired in Operation S104, a pointer to an entry node of a connection destination. Then, the process goes to Operation S106.

In Operation S106, the rule changing section 44 acquires, via the memory access section 42, information of the entry node pointed out by the pointer acquired in Operation S105. Then, the process goes to Operation S107.

In Operation S107, the rule changing section 44 determines whether a rule-change flag, included in the information of the entry node acquired in Operation S106, is “true” or not. When the rule-change flag is “true”, the process goes to Operation S108. On the other hand, when the rule-change flag is “false”, the process goes to Operation S128. The rule-change flag may indicate whether the corresponding entry node requires a scheduling rule change or not. The “true” rule-change flag indicates that the corresponding entry node requires a scheduling rule change. On the other hand, the “false” rule-change flag indicates that the corresponding entry node requires no scheduling rule change.

In Operation S108, the rule changing section 44 determines whether a rule-changed flag, included in the information of the entry node acquired in Operation S106, is “true” or not. When the rule-changed flag is “true”, the process goes to Operation S116. On the other hand, when the rule-changed flag is “false”, the process goes to Operation S109. The rule-changed flag indicates whether the scheduling rule concerning the corresponding entry node has been changed or not. The “true” rule-changed flag indicates that the scheduling rule concerning the corresponding entry node has been changed. On the other hand, the “false” rule-changed flag indicates that the scheduling rule concerning the corresponding entry node has not been changed.

In Operation S109, the rule changing section 44 acquires, out of the information of the entry node acquired in Operation S106, a pointer to a distribution node of a connection destination. Then, the process goes to Operation S110.

In Operation S110, the rule changing section 44 acquires, via the memory access section 42, information of the distribution node pointed out by the pointer acquired in Operation S109. Then, the process goes to Operation S111.

In Operation S111, the rule changing section 44 acquires, from the memory access section 42, an address of a free space of the scheduler-specific memory 50. Then, the process goes to Operation S112.

In Operation S112, via the memory access section 42, the rule changing section 44 stores the information of the distribution node, which has been acquired in Operation S110, in the free space of the scheduler-specific memory 50, e.g., at the address acquired in Operation S111. Then, the process goes to Operation S113.

In Operation S113, for the information of the entry node pointed out by the pointer acquired in Operation S105, the rule changing section 44 retracts, via the memory access section 42, the pointer to the connection destination distribution node to a field in which the pointer to the connection destination distribution node prior to change is stored. For the information of the entry node pointed out by the pointer acquired in Operation S105, the rule changing section 44 changes, via the memory access section 42, the address of the pointer to the connection destination distribution node to the address acquired in Operation S111. For the information of the entry node pointed out by the pointer acquired in Operation S105, the rule changing section 44 sets the rule-changed flag at “true” via the memory access section 42. Then, the process goes to Operation S114.

In Operation S114, the rule changing section 44 acquires, out of the information of the distribution node acquired in Operation S110, a pointer to a dispatch node of a connection destination. Then, the process goes to Operation S115.

In Operation S115, regarding the information of the dispatch node pointed out by the pointer acquired in Operation S114, the rule changing section 44 retracts, via the memory access section 42, a scheduling algorithm and an algorithm change count to a field. The field stores a pre-change scheduling algorithm and the algorithm change count concerning the connection destination dispatch node for the information of the distribution node stored in Operation S112. For the information of the dispatch node pointed out by the pointer acquired in Operation S114, the rule changing section 44 changes, via the memory access section 42, the scheduling algorithm so that the distribution node created in Operation S112 is selected on a priority basis, and increments the algorithm change count. Then, the process goes to Operation S116.

In Operation S116, the rule changing section 44 determines whether a process identification flag included in the process request information acquired in Operation S104 is “true” or not. When the process identification flag is “true”, the process goes to Operation S117. On the other hand, when the process identification flag is “false”, the process goes to Operation S128. The process identification flag indicates whether the corresponding process is a final process of the given process group or not. The “true” process identification flag indicates that the corresponding process is the final process of the given process group. On the other hand, the “false” process identification flag indicates that the corresponding process is not the final process of the given process group.

In Operation S117, the rule changing section 44 acquires, out of the information of the entry node acquired in Operation S106, a pointer to a connection destination distribution node. Then, the process goes to Operation S118.

In Operation S118, the rule changing section 44 acquires, via the memory access section 42, information of the distribution node pointed out by the pointer acquired in Operation S117. Then, the process goes to Operation S119.

In Operation S119, the rule changing section 44 acquires, out of the information of the distribution node acquired in Operation S118, a pointer to a connection destination dispatch node. Then, the process goes to Operation S120.

In Operation S120, the rule changing section 44 acquires, via the memory access section 42, information of the dispatch node pointed out by the pointer acquired in Operation S119. Then, the process goes to Operation S121.

In Operation S121, the rule changing section 44 determines whether the algorithm change count, included in the information of the dispatch node acquired in Operation S120, is greater by one than the algorithm change count included in the information of the distribution node acquired in Operation S118 or not. The algorithm change count, included in the information of the distribution node, may be the algorithm change count in the field that stores the pre-change scheduling algorithm and algorithm change count concerning the connection destination dispatch node for the information of the distribution node. When the algorithm change count included in the information of the dispatch node is greater by one than the algorithm change count included in the information of the distribution node, the process goes to Operation S125, and in other cases, the process goes to Operation S122.

In Operation S122, the rule changing section 44 acquires, via the memory access section 42, information of the other distribution node to be coupled to the dispatch node pointed out by the pointer acquired in Operation S119, for example, information of the distribution node other than the distribution node pointed out by the pointer acquired in Operation S117. Then, the process goes to Operation S123.

In Operation S123, the rule changing section 44 determines whether at least one of the algorithm change counts, included in the information of the distribution node acquired in Operation S122, is greater than the algorithm change count included in the information of the distribution node acquired in Operation S118 or not. When at least one of the algorithm change counts included in the information of the distribution node acquired in Operation S122 is greater than the algorithm change count included in the information of the distribution node acquired in Operation S118, the process goes to Operation S124. On the other hand, when the algorithm change count included in the information of the distribution node acquired in Operation S122 is smaller than the algorithm change count included in the information of the distribution node acquired in Operation S118, the process goes to Operation S125.

In Operation S124, the rule changing section 44 selects, out of the information of the distribution node acquired in Operation S122, information of the distribution node including the algorithm change count, which is greater than the algorithm change count included in the information of the distribution node acquired in Operation S118, and which is closest to the algorithm change count included in the information of the distribution node acquired in Operation S118. For the selected distribution node information, the rule changing section 44 changes, via the memory access section 42, the scheduling algorithm and algorithm change count, stored in the field that stores the pre-change scheduling algorithm and algorithm change count concerning the connection destination dispatch node, to information in the field that stores the pre-change scheduling algorithm and algorithm change count concerning the connection destination dispatch node for the information of the distribution node acquired in Operation S118. Then, the process goes to Operation S126.

In Operation S125, for the information of the dispatch node pointed out by the pointer acquired in Operation S119, the rule changing section 44 changes, via the memory access section 42, the scheduling algorithm and the algorithm change count to information in the field that stores the pre-change scheduling algorithm and the algorithm change count concerning the connection destination dispatch node for the information of the distribution node acquired in Operation S118. Then, the process goes to Operation S126.

In Operation S126, for the information of the entry node pointed out by the pointer acquired in Operation S105, the rule changing section 44 changes, via the memory access section 42, the pointer to the connection destination distribution node to information in the field that stores the pointer to the connection destination distribution node prior to the change. For the information of the entry node pointed out by the pointer acquired in Operation S105, the rule changing section 44 sets the rule-changed flag at “false” via the memory access section 42. Then, the process goes to Operation S127.

In Operation S127, the rule changing section 44 deletes, via the memory access section 42, the information of the distribution node pointed out by the pointer acquired in Operation S118. Then, the process goes to Operation S128.

In Operation S128, the rule changing section 44 ends the output of the hold signal HOLD to the scheduling section 43, thereby activating the scheduling section 43. Then, the process goes to Operation S101.

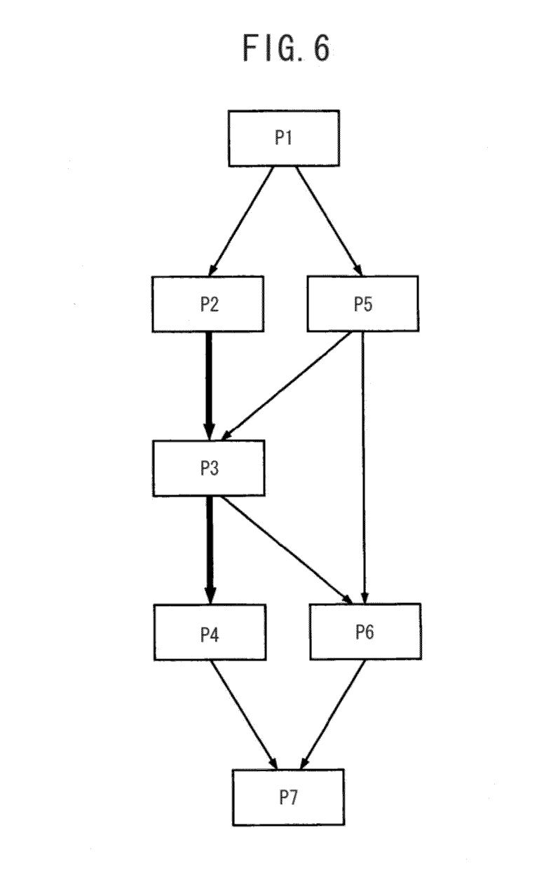

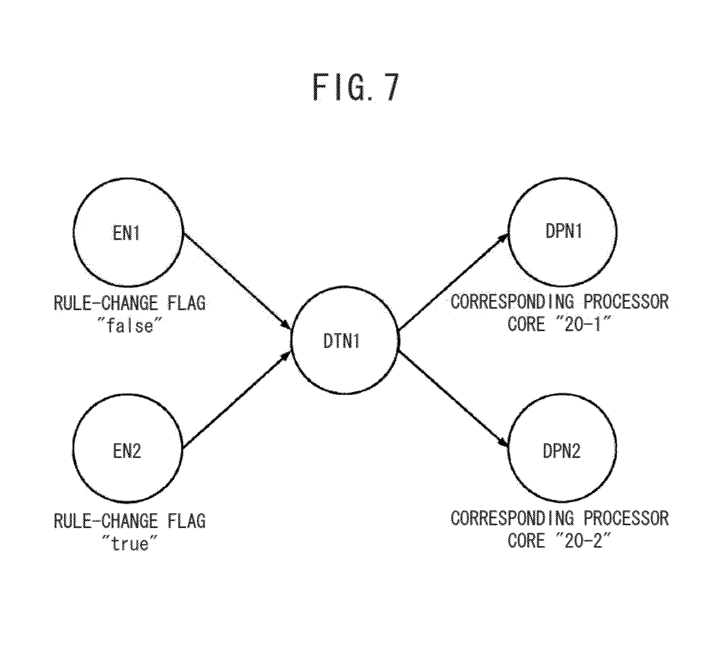

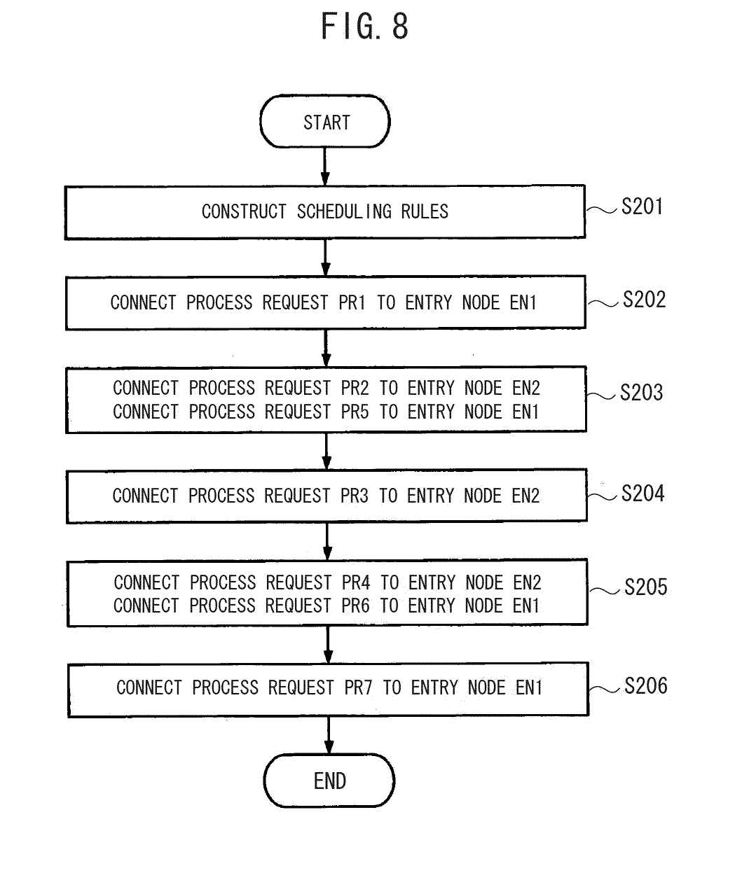

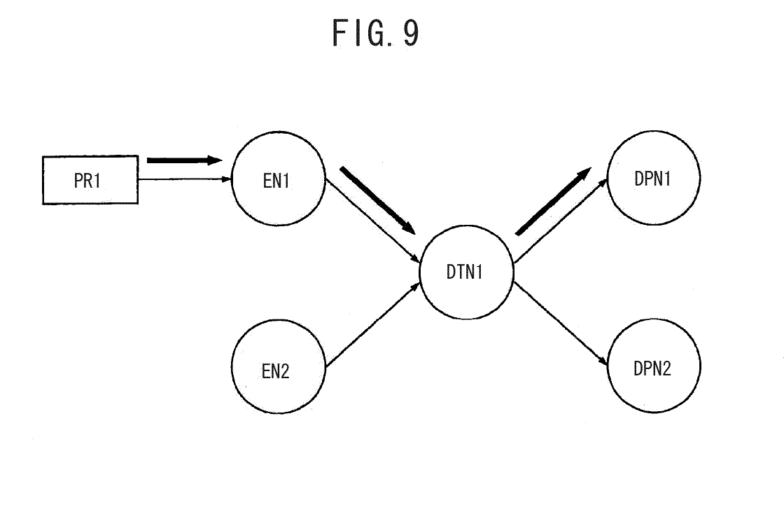

FIG. 6 illustrates an exemplary application. FIG. 7 illustrates exemplary scheduling rules. The scheduling rules illustrated in FIG. 7 may be scheduling rules for the application illustrated in FIG. 6. FIG. 8 illustrates an exemplary control program. The control program illustrated in FIG. 8 may be a control program for the application illustrated in FIG. 6. FIGS. 9 to 15 each illustrate an exemplary scheduler. The scheduler illustrated in each of FIGS. 9 to 15 may be a scheduler for the application illustrated in FIG. 6.

For example, the processor system 10 executes the application illustrated in FIG. 6. Each rectangle in FIG. 6 represents a process, each arrow in FIG. 6 represents a data-dependent relationship (data input/output relationship) between each pair of processes, and the thickness of each arrow in FIG. 6 represents a data amount shared between each pair of processes. In the application illustrated in FIG. 6, data generated in a process P1 is used in processes P2 and P5. Data generated in the process P2 is used in a process P3. Data generated in the process P3 is used in processes P4 and P6. Data generated in the process P4 is used in a process P7. Data generated in the process P5 is used in the processes P3 and P6. Data generated in the process P6 is used in the process P7. The data amount shared between the processes P2 and P3, and the data amount shared between the processes P3 and P4 may be large.

For example, the data-dependent relationship between processes in the application is analyzed, and a process group executed by the same processor core in order to suppress data transfer between processor cores, for example, a process group of a data transfer suppression target, is decided. For example, in the application illustrated in FIG. 6, the processes P2, P3, and P4 may be allocated to the same processor core. Thus, the transfer of the data shared between the processes P2 and P3 and the data shared between the processes P3 and P4 may be eliminated, thereby enhancing software execution efficiency.

How the scheduling of processes of the application is carried out to enhance processing performance is examined, thereby creating scheduling rules for the scheduler 40. In the scheduling rules, entry nodes for which the scheduling rules are not changed, distribution nodes and dispatch nodes may be provided in accordance with the number of processor cores of the processor system 10. Entry nodes, for which the scheduling rules are changed, may be provided in accordance with the number of processes included in a process group of a data transfer suppression target, which are executed at least contemporaneously.

The application illustrated in FIG. 6 may have no complicated scheduling. For example, the scheduling rules illustrated in FIG. 7 may be created. In the scheduling rules illustrated in FIG. 7, the number of processor cores of the processor system 10 is, for example, two, and dispatch nodes DPN1 and DPN2 correspond to processor cores 20-1 and 20-2, respectively. In the scheduling rules illustrated in FIG. 7, the scheduling rule for an entry node EN1 is not changed. The scheduling rule for an entry node EN2 may be changed. The scheduling rules are represented as a data structure on the scheduler-specific memory 50. A determination of whether the scheduling rule for the entry node is changed or not may be made based on the rule-change flag included in information of the entry node. For example, in the scheduling rules illustrated in FIG. 7, the rule-change flag for the entry node EN1 is set at “false”, while the rule-change flag for the entry node EN2 is set at “true”.

After the scheduling rules of the scheduler 40 have been created, programs to be executed by the processor system 10 are created. The programs may include a program for executing a process, e.g., a processing program, and a program for constructing a scheduling rule for the scheduler 40 or registering a process request such as a control program. After constructing a scheduling rule in the scheduler-specific memory 50, the control program sequentially registers process requests corresponding to processes in the scheduler 40 in accordance with data-dependent relationships between the processes. When the control program is generated, to which entry node the process request corresponding to the process is connected is decided based on a process group of a data transfer suppression target and the scheduling rules. For example, in the application illustrated in FIG. 6, the process requests corresponding to the processes P2, P3, and P4, which are decided as a process group of a data transfer suppression target, are coupled to the entry node EN2. The process requests corresponding to the other processes P1, P5, P6, and P7 are coupled to the entry node EN1. Since the process P4 is the final process of the process group of a data transfer suppression target, the process identification flag of the process request for the process P4 is set at “true”. Since the processes P1 to P3 and P5 to P7 are not the final process of the process group of a data transfer suppression target, the process identification flags of the process requests for the processes P1 to P3 and P5 to P7 are set at “false”.

In Operation S201 in FIG. 8, the control program constructs scheduling rules in the scheduler-specific memory 50. Then, the process goes to Operation S202.

In Operation S202, the control program connects a process request PR1 corresponding to the process P1 to the entry node EN1. Then, the process goes to Operation S203.

In Operation S203, with the end of execution of the process P1, the control program connects a process request PR2 corresponding to the process P2 to the entry node EN2, and connects a process request PR5 corresponding to the process P5 to the entry node EN1. Then, the process goes to Operation S204.

In Operation S204, with the end of execution of the process P2 and the end of execution of the process P5, the control program connects a process request PR3 corresponding to the process P3 to the entry node EN2. Then, the process goes to Operation S205.

In Operation S205, with the end of execution of the process P3, the control program connects a process request PR4 corresponding to the process P4 to the entry node EN2, and connects a process request PR6 corresponding to the process P6 to the entry node EN1. Then, the process goes to Operation S206.

In Operation S206, with the end of execution of the process P4 and the end of execution of the process P6, the control program connects a process request PR7 corresponding to the process P7 to the entry node EN1.

As illustrated in FIG. 9, the process request PR1 corresponding to the process P1 is coupled to the entry node EN1. The processor cores 20-1 and 20-2 corresponding to the dispatch nodes DPN1 and DPN2, respectively, are free. Therefore, the process P1 may be allocated to either of the dispatch nodes DPN1 and DPN2. For example, the process P1 is allocated to the dispatch node DPN1, and the processor core 20-1 executes the process P1.

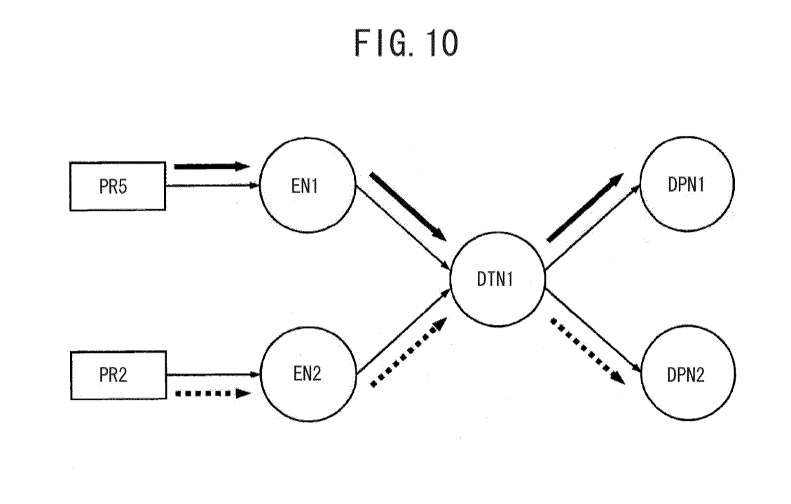

After the execution of the process P1 by the processor core 20-1 has been ended, the process request PR5 corresponding to the process P5 is coupled to the entry node EN1, and the process request PR2 corresponding to the process P2 is coupled to the entry node EN2, as illustrated in FIG. 10. For example, the process P5 is allocated to the dispatch node DPN1, and the process P2 is allocated to the dispatch node DPN2. The processor core 20-1 executes the process P5, and the processor core 20-2 executes the process P2.

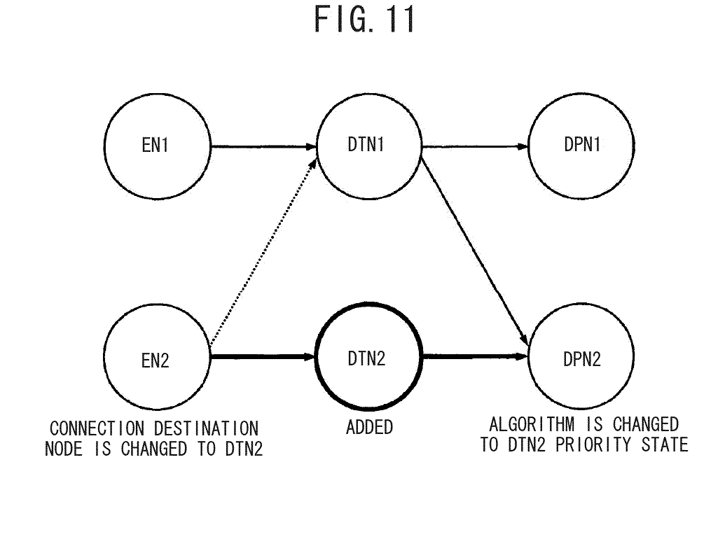

When the dispatch node DPN2 is decided as the allocation destination for the process P2, whose process request is coupled to the entry node EN2, the scheduling rules are changed as illustrated in FIG. 11. A distribution node DTN2 coupled to the dispatch node DPN2 is added, and the connection destination for the entry node EN2 is changed to the distribution node DTN2. Information, indicating that the entry node EN2 has been coupled to a distribution node DTN1 prior to the rule change, is stored in the entry node EN2. The rule-changed flag of the entry node EN2 is set at “true”. The process, whose process request is coupled to the entry node EN2, is allocated to the dispatch node DPN2 via the distribution node DTN2. When the process P2 is allocated to the dispatch node DPN1, the distribution node DTN2 coupled to the dispatch node DPN1 is added. The process, whose process request is coupled to the entry node EN2, is allocated to the dispatch node DPN1 via the distribution node DTN2.

The process, whose process request is coupled to the entry node EN2, is allocated to the dispatch node DPN2. Therefore, when a scheduling algorithm for the dispatch node DPN2 is changed so that the distribution node DTN2 is selected on a priority basis, software execution efficiency may be enhanced. The pre-change scheduling algorithm for the dispatch node DPN2 is stored in the distribution node DTN2.

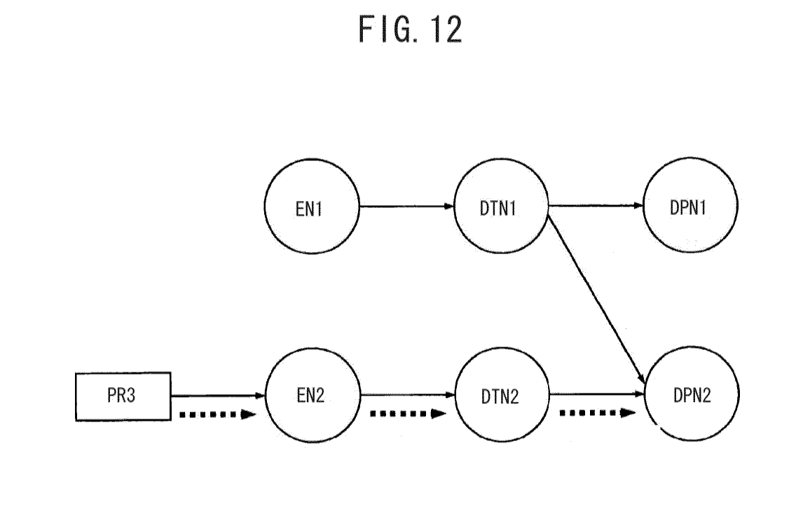

When the execution of the process P5 by the processor core 20-1 and execution of the process P2 by the processor core 20-2 are complete, the process request PR3 corresponding to the process P3 is coupled to the entry node EN2 as illustrated in FIG. 12. Since the entry node EN2 is coupled to the distribution node DTN2, and the distribution node DTN2 is coupled to the dispatch node DPN2, the process P3 may be allocated to the dispatch node DPN2, for example, the dispatch node to which the process P2 has been allocated. The processor core 20-2 executes the process P3. Since the rule-changed flag of the entry node EN2 is set at “true”, the scheduling rules are not changed.

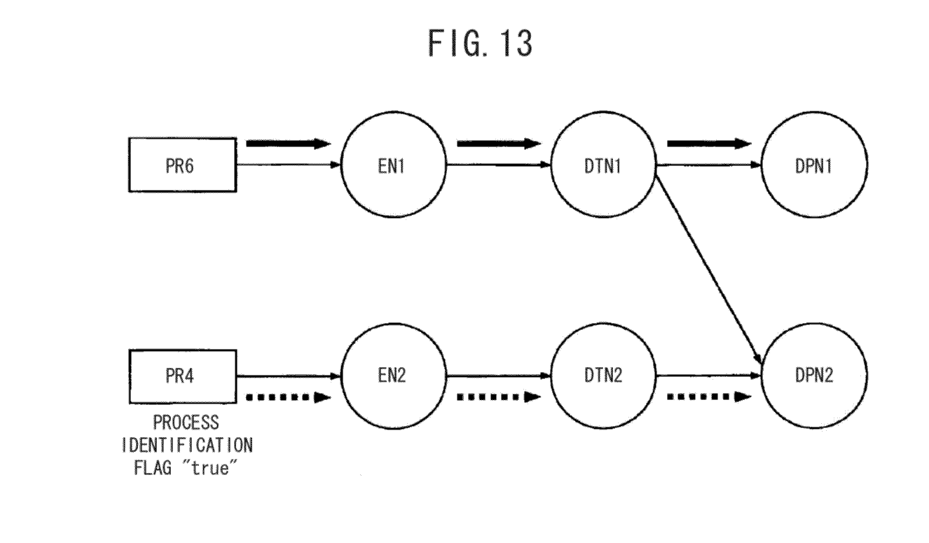

When the execution of the process P3 by the processor core 20-2 is complete, the process request PR4 corresponding to the process P4 is coupled to the entry node EN2, and the process request PR6 corresponding to the process P6 is coupled to the entry node EN1, as illustrated in FIG. 13. The process P6 may be allocated to either of the dispatch nodes DPN1 and DPN2 via the distribution node DTN1. Since the scheduling algorithm for the dispatch node DPN2 is changed so that the distribution node DTN2 is selected on a priority basis, the process P6 is allocated to the dispatch node DPN1, and the process P4 is allocated to the dispatch node DPN2. The processor core 20-1 executes the process P6, and the processor core 20-2 executes the process P4.

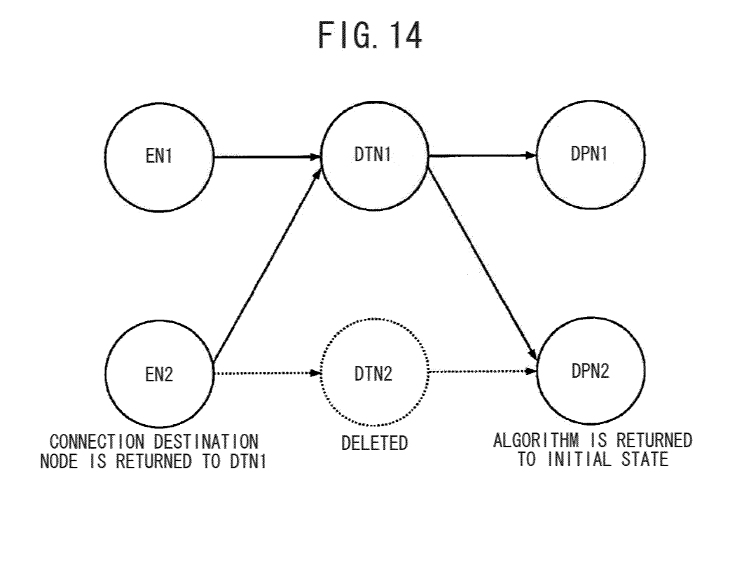

The process identification flag of the process request PR4 corresponding to the process P4 is set at “true”. Therefore, when the dispatch node DPN2 is decided as the allocation destination for the process P4, the scheduling rules are restored as illustrated in FIG. 14. The distribution node DTN2 is deleted, and the connection destination for the entry node EN2 is returned to the distribution node DTN1. Further, using the pre-change scheduling algorithm for the dispatch node DPN2, which is saved to the distribution node DTN2, the scheduling algorithm for the dispatch node DPN2 is returned to an initial state, for example, a pre-change state. The rule-changed flag of the entry node EN2 is set at “false”.

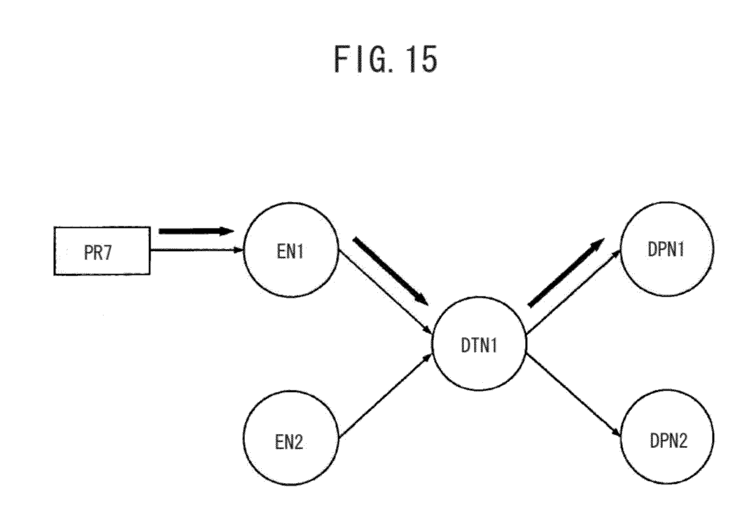

When the execution of the process P6 by the processor core 20-1 and the execution of the process P4 by the processor core 20-2 are complete, the process request PR7 corresponding to the process P7 is coupled to the entry node EN1 as illustrated in FIG. 15. The process P7 may be allocated to either of the dispatch nodes DPN1 and DPN2. For example, the process P7 is allocated to the dispatch node DPN1. The processor core 20-1 executes the process P7.

In the scheduler 40 of the distributed memory type multicore processor system 10, the rule changing section 44 changes scheduling rules when the scheduling section 43 has decided, in accordance with the load status of each processor core, the allocation destination for the first process of a process group of a data transfer suppression target. The scheduling section 43 allocates the processor core, which is the same core as that to which the first process has been allocated, to the subsequent process of the process group of a data transfer suppression target. Thus, for the process group of a data transfer suppression target, the data transfer between processor cores is reduced. After the scheduling section 43 has allocated the allocation destination for the final process of the process group of a data transfer suppression target to the same processor core as that to which the first process has been allocated, the rule changing section 44 restores the scheduling rules. When a process request corresponding to the first process of a process group of a data transfer suppression target is registered again, the scheduling section 43 decides, in accordance with the load status of each processor core, the allocation destination for the first process of the process group of a data transfer suppression target. Thus, the dynamic load balancing and the reduction of the data transfer between processor cores are realized, thereby enhancing software execution efficiency.

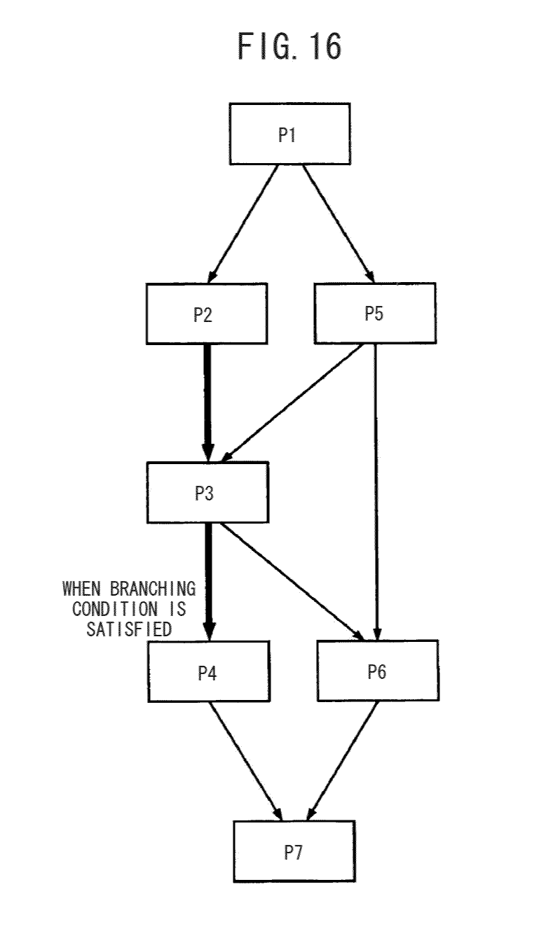

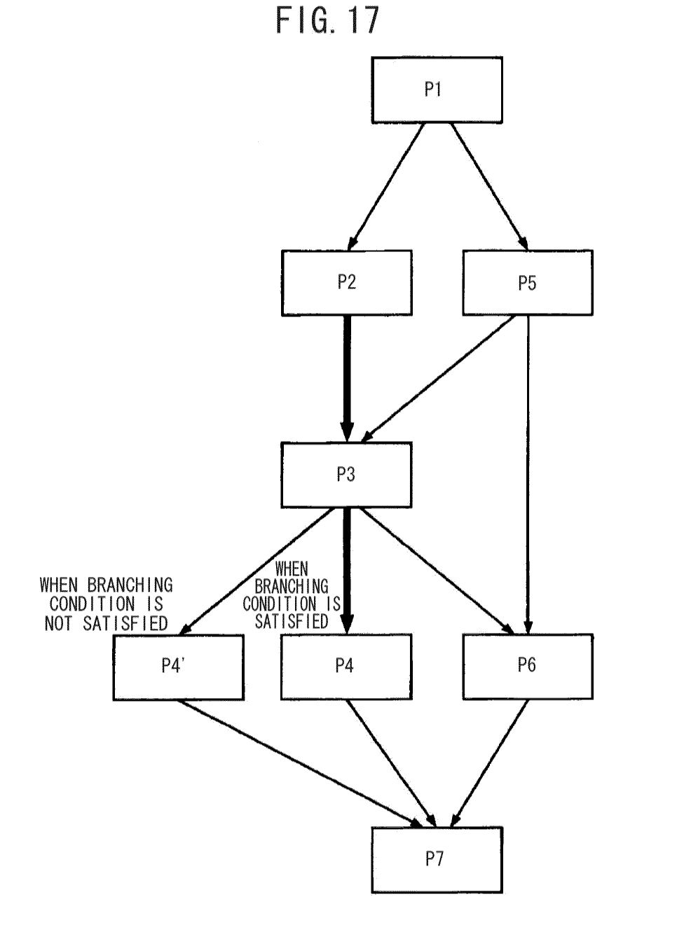

FIG. 16 illustrates another exemplary application. FIG. 17 illustrates an exemplary conditional branching method. The conditional branching method, which is illustrated in FIG. 17, may correspond to the application illustrated in FIG. 16. For example, the processor system 10 executes the application illustrated in FIG. 16. Programs of the application may include conditional branching. When a branching condition is satisfied, the process P4 is executed, and the process P7 is executed using data generated in the process P4 and data generated in the process P6. When no branching condition is satisfied, the process P4 is not executed, and the process P7 is executed using the data generated in the process P6. The other elements of the application illustrated in FIG. 16 may be substantially the same as or analogous to those of the application illustrated in FIG. 6.

In the application illustrated in FIG. 16, a process request corresponding to process P4 may be registered in the scheduler 40. When the processes P2, P3, and P4 are decided as a process group of a data transfer suppression target, the scheduling rules may be restored for the process P4, which is the final process of the process group of a data transfer suppression target, after the scheduler 40 has changed the scheduling rules with a decision on the allocation destination for the first process, for example, the process P2.

When no branching condition is satisfied, a process P4′ executed when the process P4, for example, is not executed is added. The process P4′ may generate data to be used in the process P7 using data generated in the process P3, but may execute substantially nothing. The processes P2, P3, P4, and P4′ are decided as a process group serving of transfer suppression target. In the processes P4 and P4′ as the final process of the process group of a data transfer suppression target, the process identification flag of the process request is set at “true”. Even if the process request corresponding to the process P4 is not registered after the scheduler 40 has changed the scheduling rules with a decision on the allocation destination for the process P2, the process request corresponding to the process P4′ is registered, thereby restoring the scheduling rules.

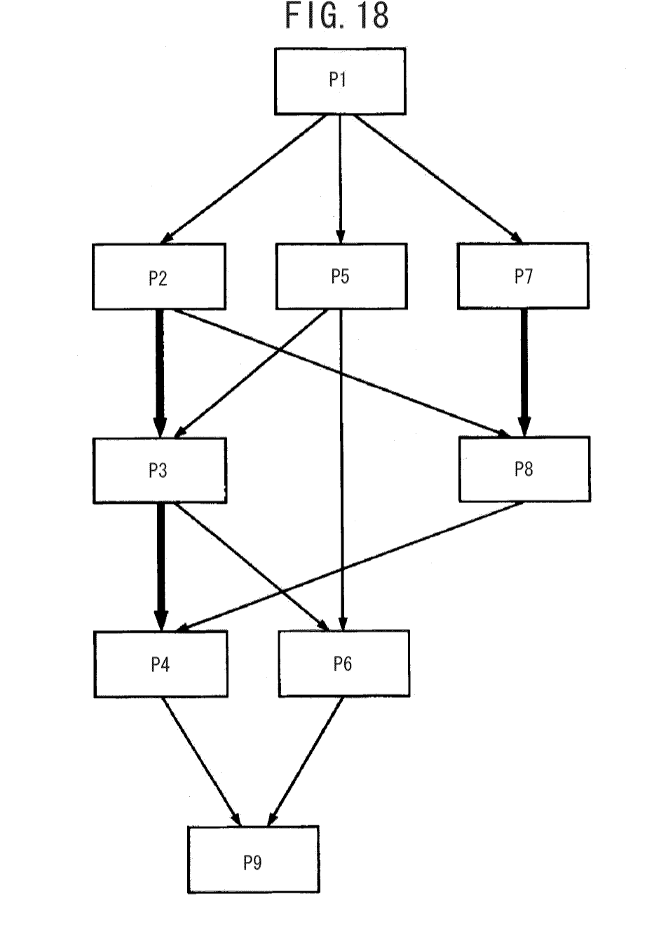

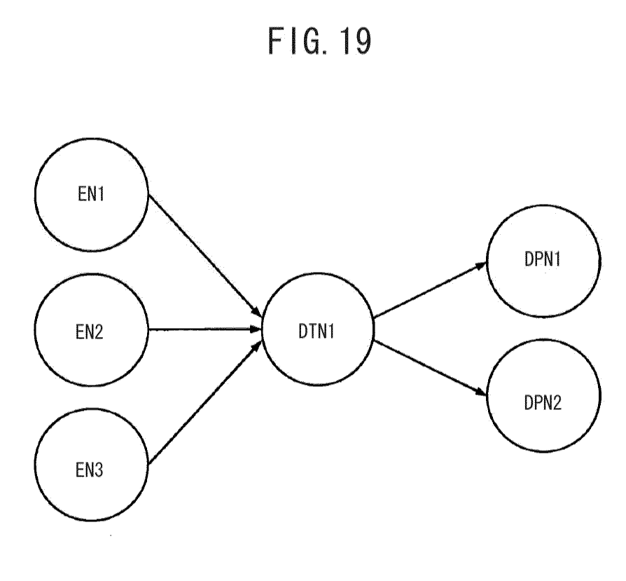

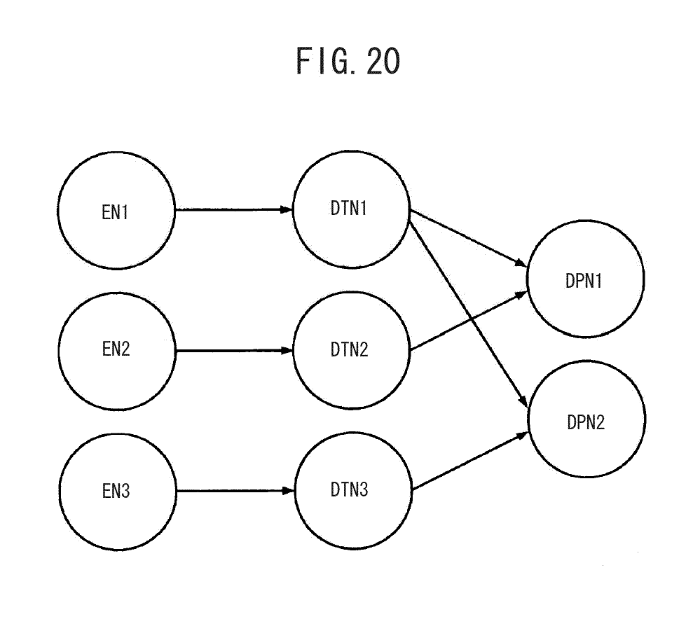

FIG. 18 illustrates another exemplary application. FIG. 19 illustrates exemplary scheduling rules. The scheduling rules illustrated in FIG. 19 may correspond to the application illustrated in FIG. 18. FIG. 20 illustrates exemplary scheduling rule changes. The scheduling rule changes illustrated in FIG. 20 may correspond to the scheduling rules illustrated in FIG. 19. In the application illustrated in FIG. 18, the data amount shared between the processes P2 and P3, the data amount shared between the processes P3 and P4, and the data amount shared between the processes P7 and P8 may be large. The processes P2, P3, and P4, and the processes P7 and P8 are each decided as a process group of a data transfer suppression target, and the scheduling rules illustrated in FIG. 19, for example, are created.

In the scheduling rules illustrated in FIG. 19, the entry node EN1 where no scheduling rule is changed is provided, and the entry nodes EN2 and EN3 where the scheduling rules are changed are provided so that the two process groups of a data transfer suppression target, for example, the processes P2, P3, and P4 and the processes P7 and P8, are contemporaneously executed. For example, a control program is created so that process requests corresponding to the processes P1, P5, P6, and P9 are coupled to the entry node EN1, process requests corresponding to the processes P2, P3, and P4 are coupled to the entry node EN2, and process requests corresponding to the processes P7 and P8 are coupled to the entry node EN3. The scheduler 40 allocates the processes P2, P3, and P4 to the same processor core, and allocates the processes P7 and P8 to the same processor core.

After the execution of the process P1 has been ended, the process requests corresponding to the processes P5, P2, and P7 are coupled to the entry nodes EN1, EN2, and EN3, respectively. When the process P2 is allocated to the dispatch node DPN1 and the process P7 is allocated to the dispatch node DPN2, the scheduling rules are changed to a state illustrated in FIG. 20, for example. A distribution node DTN2 coupled to the dispatch node DPN1 is added, and the connection destination for the entry node EN2 is changed to the distribution node DTN2. The scheduling algorithm for the dispatch node DPN1 is changed so that the distribution node DTN2 is selected on a priority basis. A distribution node DTN3 coupled to the dispatch node DPN2 is added, and the connection destination for the entry node EN3 is changed to the distribution node DTN3. The scheduling algorithm for the dispatch node DPN2 is changed so that the distribution node DTN3 is selected on a priority basis.

Information, indicating that the entry node EN2 has been coupled to the distribution node DTN1 before the rule change concerning the entry node EN2, is stored in the entry node EN2. The pre-change scheduling algorithm for the dispatch node DPN1 is stored in the distribution node DTN2. Information, indicating that the entry node EN3 has been coupled to the distribution node DTN1 before the rule change concerning the entry node EN3, is stored in the entry node EN3. The pre-change scheduling algorithm for the dispatch node DPN2 is stored in the distribution node DTN3. The scheduler 40 restores the rules concerning the entry nodes EN2 and EN3 by using these pieces of information, and returns the scheduling rules to the initial state, for example, the state illustrated in FIG. 19, irrespective of the rule change execution order and/or rule restoration execution order concerning the entry nodes EN2 and EN3.

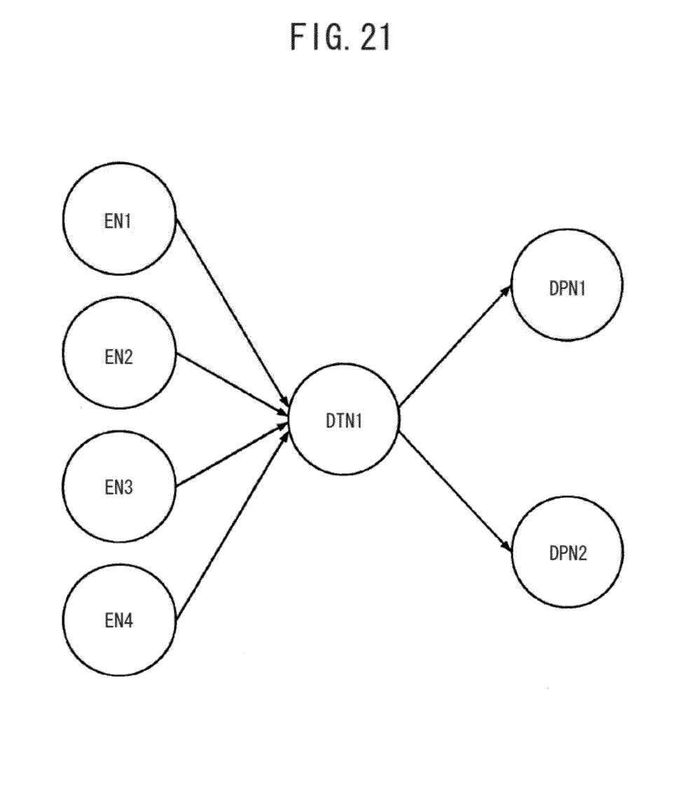

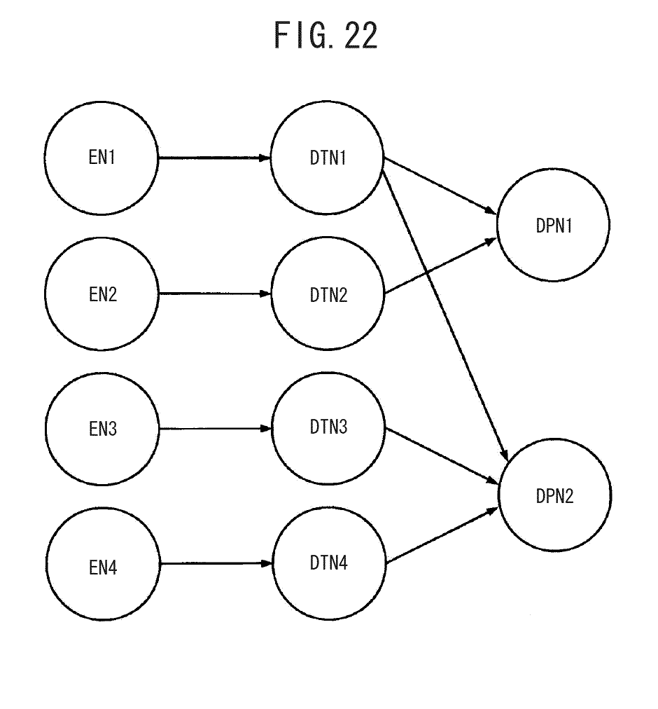

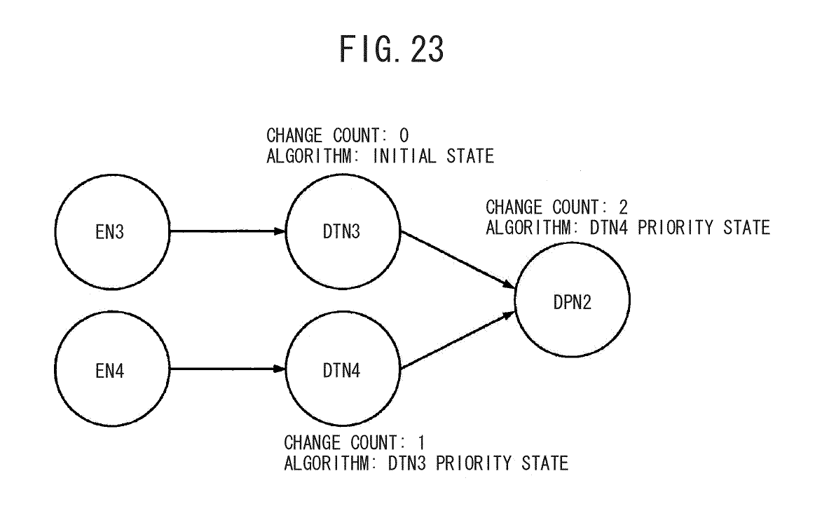

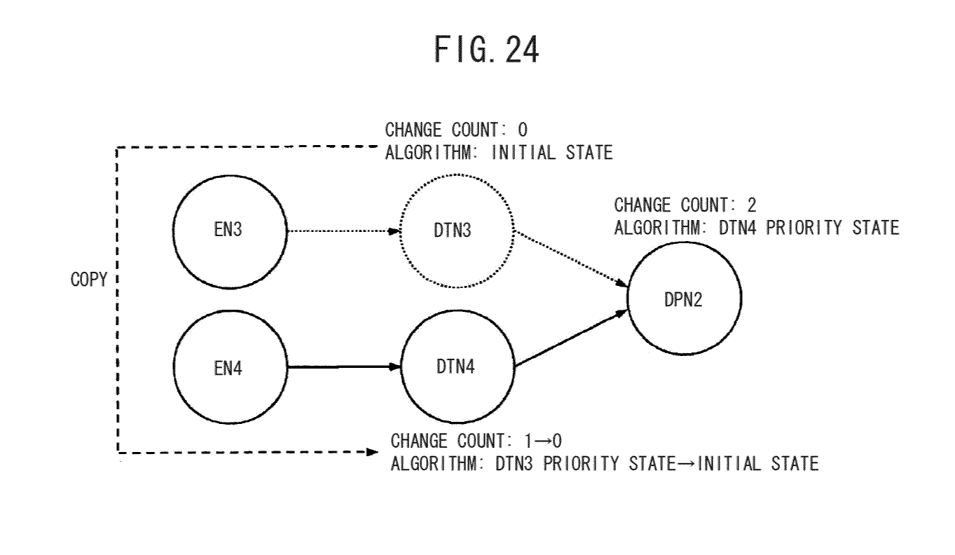

FIG. 21 illustrates exemplary scheduling rules. The scheduling rules illustrated in FIG. 21 may be applied to the other applications. FIG. 22 illustrates exemplary changes in scheduling rules. The changes in scheduling rules illustrated in FIG. 22 may be changes in the scheduling rules illustrated in FIG. 21. FIG. 23 illustrates an exemplary principal part of scheduling rules. FIG. 23 may illustrate the principal part of the scheduling rules illustrated in FIG. 22. FIG. 24 illustrates an exemplary restoration of scheduling rules. FIG. 24 may illustrate the restoration of the scheduling rules illustrated in FIG. 23.

The scheduling algorithm for a dispatch node may be changed a plurality of times. In the scheduling rules for an application, which are illustrated in FIG. 21, for example, the scheduling rule for the entry node EN1 is not changed, but the scheduling rules for the entry nodes EN2, EN3, and EN 4 are changed. The entry nodes EN1 to EN4 are coupled to the distribution node DTN1, and the distribution node DTN1 is coupled to the dispatch nodes DPN1 and DPN2.

At the time of a rule change, a distribution node is added. The scheduling algorithm for the dispatch node, to which the added distribution node is coupled, is changed so that the added distribution node is selected on a priority basis. In the scheduling rules illustrated in FIG. 21, the rules are changed three times for the two dispatch nodes, and therefore, the scheduling algorithm for either the dispatch node DPN1 or DPN2 is changed twice or more.

For example, in the scheduling rules illustrated in FIG. 21, the rules are changed in the order of entry nodes EN2, EN3, and EN4, and the scheduling rules are changed to those illustrated in FIG. 22, for example. In the scheduling rules illustrated in FIG. 22, a distribution node DTN2, added at the time of the rule change of the entry node EN2, is coupled to the dispatch node DPN1, while a distribution node DTN3, added at the time of the rule change of the entry node EN3, and a distribution node DTN4, added at the time of the rule change of the entry node EN4, are coupled to the dispatch node DPN2. The scheduling algorithm for the dispatch node DPN2 is changed so that the distribution node DTN3 is selected on a priority basis at the time of the rule change of the entry node EN3, and is then changed so that the distribution node DTN4 is selected on a priority basis at the time of the rule change of the entry node EN4. The scheduling algorithm prior to the rule change of the entry node EN3 for the dispatch node DPN2 is stored to the distribution node DTN3, while the scheduling algorithm prior to the rule change of the entry node EN4 for the dispatch node DPN2 is stored to the distribution node DTN4.

When the rule restoration of the entry node EN3 and the rule restoration of the entry node EN4 have been completed, an order of the restoration procedure of the scheduling algorithm for the dispatch node DPN2 is changed to return the scheduling algorithm for the dispatch node DPN2 to an initial state. The change of the restoration procedure is performed based on whether the rule restoration of the entry node EN3 or the rule restoration of the entry node EN4 is carried out first.

At the time of rule restoration, the scheduler 40 uses the algorithm change count for the dispatch node to which the distribution node to be deleted is coupled, and the algorithm change count stored to the distribution node coupled to the dispatch node, for example, the pre-change algorithm change count for the connection destination dispatch node, thereby deciding the restoration procedure of the scheduling algorithm for the dispatch node to which the distribution node to be deleted is coupled.

When the algorithm change count for the distribution node to be deleted is the largest among the algorithm change counts for each of the distribution nodes coupled to the connection destination dispatch node, the scheduling algorithm and the algorithm change count for the distribution node to be deleted are written back to the connection destination dispatch node. When the algorithm change count for the distribution node to be deleted is not the largest among the algorithm change counts for each of the distribution nodes coupled to the connection destination dispatch node, the distribution node, to which the smallest algorithm change count (e.g., the algorithm change count closest to the algorithm change count for the distribution node to be deleted) is saved, is determined from among the distribution nodes to which the algorithm change counts larger than the algorithm change count for the distribution node to be deleted are saved. The scheduling algorithm and algorithm change count for the distribution node to be deleted are copied to the determined distribution node.

FIG. 23 illustrates an exemplary algorithm change count and an exemplary scheduling algorithm. The exemplary algorithm change count and the exemplary scheduling algorithm may be the algorithm change count and the scheduling algorithm for the dispatch node DPN2 in the scheduling rules illustrated in FIG. 22. Further, FIG. 23 illustrates an exemplary algorithm change count and an exemplary scheduling algorithm. The exemplary algorithm change count and the exemplary scheduling algorithm may be the algorithm change count and the scheduling algorithm before a change of the dispatch node DPN2 to be stored in the distribution node DTN3 in the scheduling rules illustrated in FIG. 22, for example, before an addition of the distribution node DTN3. The exemplary algorithm change count and the exemplary scheduling algorithm may be the algorithm change count and the scheduling algorithm before a change of the dispatch node DPN2 to be stored in the distribution node DTN4 in the scheduling rules illustrated in FIG. 22, for example, before an addition of the distribution node DTN4.

At the time of a rule change, a distribution node is added, and the scheduling algorithm is changed so that the added distribution node is selected on a priority basis and the algorithm change count is incremented in a dispatch node of a connection destination for the added distribution node. The scheduling algorithm and algorithm change count before a change of the connection destination dispatch node are stored in the added distribution node. In the scheduling rules illustrated in FIG. 23, the rule change of the entry node EN4 is performed after the rule change of the entry node EN3 has been performed. Therefore, in the dispatch node DPN2, the algorithm change count may be set at twice, and the scheduling algorithm may be set at a distribution node DTN4 priority state. The algorithm change count for example, zero and scheduling algorithm, for example, an initial state for the dispatch node DPN2 before the rule change of the entry node EN3 is carried out are stored in the distribution node DTN3. The algorithm change count, for example, once, and a scheduling algorithm, for example, a distribution node DTN3 priority state for the dispatch node DPN2 after the rule change of the entry node EN3, are stored in the distribution node DTN4.

When the rule restoration of the entry node EN4 is performed first for the scheduling rules illustrated in FIG. 23, the algorithm change count (e.g., once) and scheduling algorithm (e.g., the distribution node DTN3 priority state) for the distribution node DTN4 are written back to the dispatch node DPN2 at the time of rule restoration. Also for the entry node EN3, the algorithm change count (e.g., zero) and scheduling algorithm (e.g., the initial state) for the distribution node DTN3 are written back to the dispatch node DPN2 at the time of rule restoration. Thus, the scheduling algorithm for the dispatch node DPN2 is returned to the initial state.

When the rule restoration of the entry node EN3 is performed first, the scheduling algorithm for the distribution node DTN3 (e.g., the initial state) is written back to the dispatch node DPN2 at the time of rule restoration. Therefore, at the time of rule restoration of the entry node EN4, the scheduling algorithm for the dispatch node DPN2 (e.g., the initial state) is overwritten by the scheduling algorithm for the distribution node DTN4 (e.g., the distribution node DTN3 priority state), and the scheduling algorithm for the dispatch node DPN2 is not returned to the initial state.

When the rule restoration of the entry node EN3 is performed first, the algorithm change count (e.g., zero) and scheduling algorithm (e.g., the initial state) for the distribution node DTN3 are copied to the distribution node DTN4 at the time of rule restoration as illustrated in FIG. 24, for example. At the time of rule restoration of the entry node EN4, the algorithm change count (e.g., zero) and scheduling algorithm (e.g., the initial state) for the distribution node DTN4 are written back to the dispatch node DPN2. Thus, the scheduling algorithm for the dispatch node DPN2 is returned to the initial state.

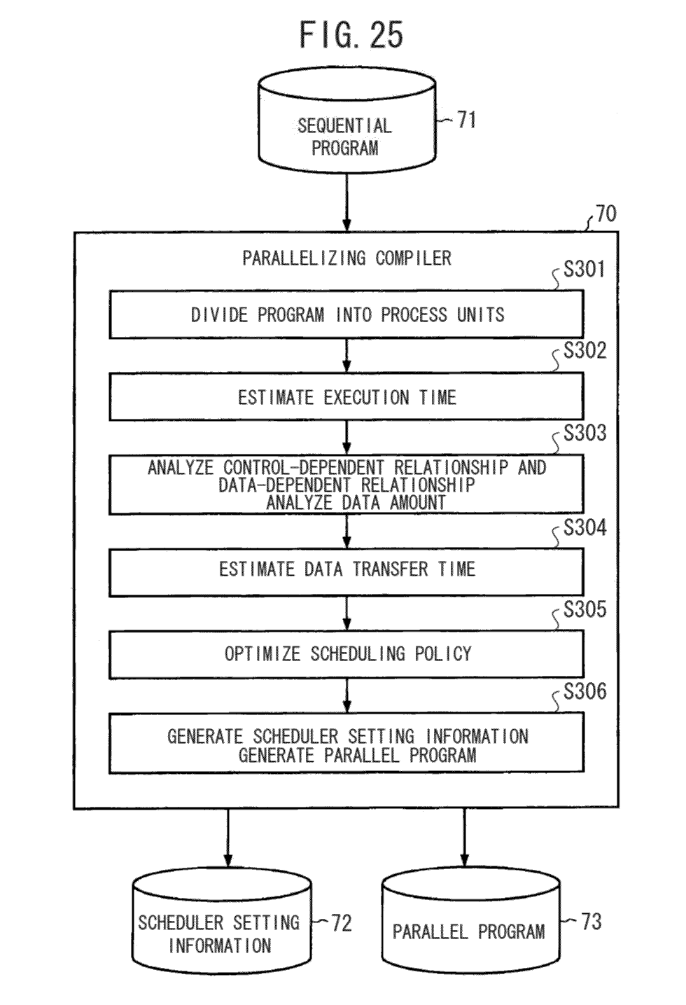

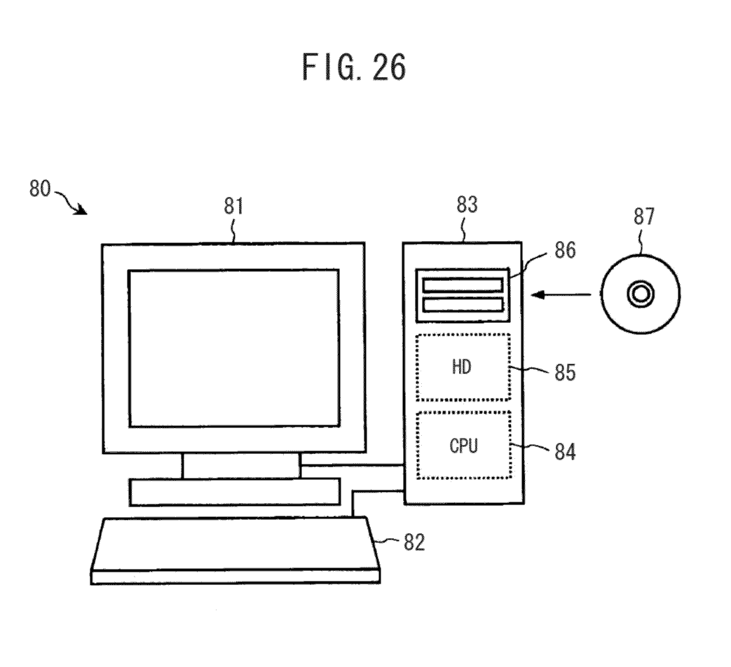

FIG. 25 illustrates an exemplary parallelizing compiler. FIG. 26 illustrates an exemplary execution environment for the parallelizing compiler.

When a parallelizing compiler generates a parallel program from a sequential program, scheduler setting information indicative of a scheduling policy is generated. Therefore, the operations for program development may be reduced. For example, a scheduling policy includes: a number of entry nodes; a setting of a rule-change flag of each entry node, for example, a setting of “true”/“false”; a number of distribution nodes; a number of dispatch nodes; relationships between dispatch nodes and processor cores; relationships between processes and entry nodes; connection relationships between entry nodes and distribution nodes; and connection relationships between distribution nodes and dispatch nodes.

A parallelizing compiler 70 receives a sequential program 71, and outputs scheduler setting information 72 and a parallel program 73. The parallelizing compiler 70 may be executed on a workstation 80 illustrated in FIG. 26, for example. The workstation 80 includes a display device 81, a keyboard device 82, and a control device 83. The control device 83 includes a CPU (Central Processing Unit) 84, an HD (Hard Disk) 85, a recording medium drive device 86, or the like. In the workstation 80, a compiler program, which is read from a recording medium 87 via the recording medium drive device 86, is stored on the HD 85. The CPU 84 executes the compiler program stored on the HD 85.

In Operation S301, the parallelizing compiler 70 divides the sequential program 71 into process units. For example, the parallelizing compiler 70 divides the sequential program 71 into process units based on a basic block and/or a procedure call. The parallelizing compiler 70 may divide the sequential program 71 into process units based on a user's instruction by a pragma or the like. Then, the process goes to Operation S302.

In Operation S302, the parallelizing compiler 70 estimates an execution time for the process obtained in Operation S301. For example, the parallelizing compiler 70 estimates the execution time for the process based on the number of program lines, loop counts, and the like. The parallelizing compiler 70 may use execution time for the process, which is given by a user such as a pragma, based on past records, experience, and the like. Then, the process goes to Operation S303.

In Operation S303, the parallelizing compiler 70 analyzes a control-dependent relationship and a data-dependant relationship between processes, and generates a control flow graph (CFG) and/or a data flow graph (DFG). For example, a control-dependent relationship and a data-dependant relationship, described in a document such as “Structure and Optimization of Compiler” (written by Ikuo Nakata and published by Asakura Publishing Co., Ltd. in September 1999 (ISBN4-254-12139-3)) or “Compilers: Principles, Techniques and Tools” (written by A. V. Aho, R. Sethi, and J. D. Ullman, and published by SAIENSU-SHA Co., Ltd. in October 1990 (ISBN4-7819-0585-4)), may be used.

When analyzing a data-dependent relationship between processes, the parallelizing compiler 70 derives, for each pair of processes having a data-dependent relationship, a data amount shared between the pair of processes in accordance with a type of intervening variable. For example, when the variable type is a basic data type, a char type, an int type, a float type, or the like, a basic data size is used as the data amount shared between a pair of processes. When the variable type is a structure type, a sum of a data amount of structure members is used as the data amount shared between a pair of processes. When the variable type is a union type, a maximum among data amount of union members is used as the data amount shared between a pair of processes. When the variable type is a pointer type, a value estimated from a data amount of a variable and/or a data region having a possibility of being pointed out by a pointer is used as the data amount shared between a pair of processes. When substitution is made by address calculation, a data amount of a variable to be subjected to the address calculation is used as the data amount shared between a pair of processes. When substitution is made by dynamic memory allocation, a product of a data amount of array elements and an array size, for example, a product of a number of elements is used as the data amount shared between a pair of processes. When there are a plurality of data amounts, a maximum value or an average value of the plurality of data amounts is used as the data amount shared between a pair of processes. Then, the process goes to Operation S304.

In Operation S304, the parallelizing compiler 70 estimates, for each pair of processes having a data-dependent relationship, a data transfer time where respective processes of the pair of processes are allocated to different processor cores. For example, the product of the data amount derived in Operation S303 and a latency, for example, the product of time for transfer of a unit data amount and a constant, is used as data transfer time for each pair of processes. Then, the process goes to Operation S305.

In Operation S305, the parallelizing compiler 70 carries out a scheduling policy optimization process based on analysis of the control-dependent relationship and data-dependent relationship between processes; for example, based on a control flow graph and a data flow graph; and/or based on an estimation of execution time for each process and data transfer time for each pair of processes having a data-dependent relationship, which have been obtained in Operations S302 to S304. Then, the process goes to Operation S306.

In Operation S306, the parallelizing compiler 70 generates the scheduler setting information 72 indicating the scheduling policy obtained in Operation S305. The parallelizing compiler 70 generates the parallel program 73 in accordance with intermediate representation.

When the parallel program 73 is generated by an asynchronous remote procedure call, the parallelizing compiler 70 generates a program for each process in a procedure format. The parallelizing compiler 70 generates a procedure for receiving, as an argument, an input variable that is based on a data-dependent relationship analysis, and returning, as a returning value, an output variable value, or receiving, as an argument, an address at which an output variable value is stored. The parallelizing compiler 70 determines, from among variables used for a partial program that is a part of a process, a variable other than input variables, and generates a code for declaring the variable. After having output the partial program, the parallelizing compiler 70 generates a code for returning an output variable value as a returning value or a code for substituting an output variable value into an address input as an argument. The passing of data between processes belonging to the same process group of a data transfer suppression target is excluded. The parallelizing compiler 70 generates a program for replacing a process with the asynchronous remote procedure call. Based on a data-dependent relationship analysis, the parallelizing compiler 70 generates a code for using a process execution result or a code for waiting for an asynchronous remote procedure call for a process prior to a call for the process. The data-dependent relationship between processes belonging to the same process group of a data transfer suppression target is excluded.

When generating the parallel program 73 based on a thread, for example, the parallelizing compiler 70 generates a program for each process in a thread format. The parallelizing compiler 70 determines a variable used for a partial program of a part of a process, and generates a code for declaring the variable. The parallelizing compiler 70 generates a code for receiving an input variable that is based on data-dependent relationship analysis, and a code for receiving a message indicative of an execution start. After having output the partial program, the parallelizing compiler 70 generates a code for transmitting an output variable, and a code for transmitting a message indicative of an execution end. The passing of data between processes belonging to the same process group of a data transfer suppression target is excluded. The parallelizing compiler 70 generates a program in which each process is replaced with transmission of a thread activation message. The parallelizing compiler 70 generates a code for using an execution result of a process or a code for receiving an execution result of a process prior to a call for the process based on a data-dependent relationship analysis. The data-dependent relationship between processes belonging to the same process group of a data transfer suppression target is excluded. When loop carry-over occurs, the parallelizing compiler 70 generates a code for receiving a message indicative of the execution end prior to thread activation at the time of the loop carry-over, and generates a code for receiving a message indicative of the execution end for all threads at the end of the program.

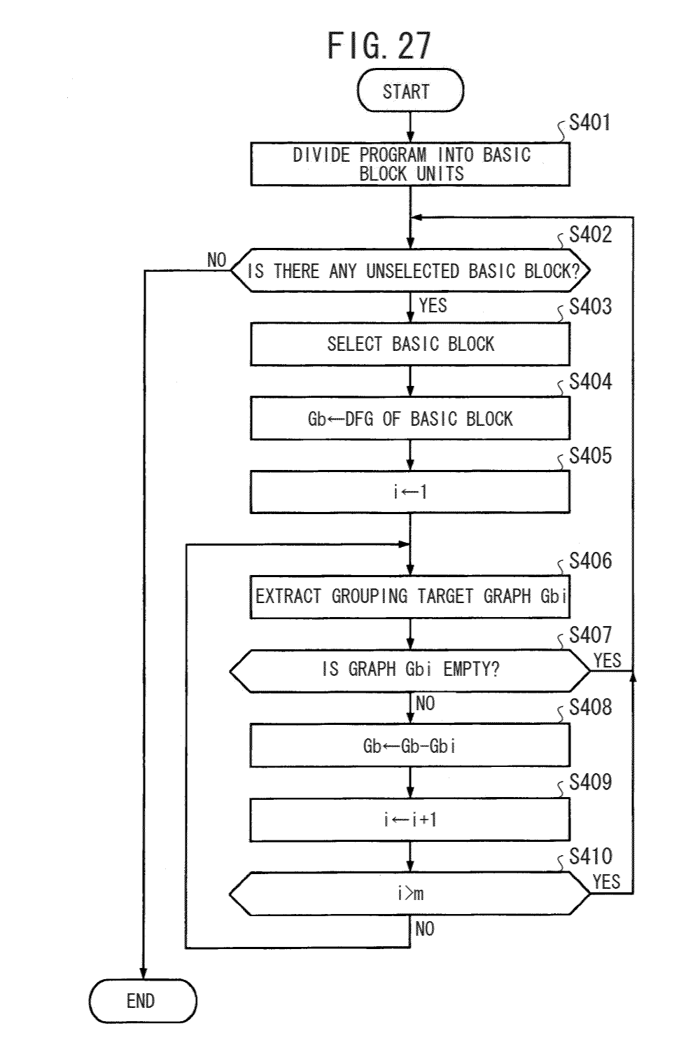

FIG. 27 illustrates an exemplary scheduling policy optimization process.

In Operation S401, the parallelizing compiler 70 divides the sequential program 71 into basic block units based on a control flow graph (CFG). Then, the process goes to Operation S402.

In Operation S402, for a plurality of basic blocks obtained in Operation S401, the parallelizing compiler 70 determines whether there is any unselected basic block or not. When there is an unselected basic block, the process goes to Operation S403. On the other hand, when there is no unselected basic block, the scheduling policy optimization process is ended, and the process goes to Operation S306 in FIG. 25.

In Operation S403, the parallelizing compiler 70 selects one of unselected basic blocks. Then, the process goes to Operation S404.

In Operation S404, the parallelizing compiler 70 sets, as a graph Gb, a data flow graph (DFG) of the basic block selected in Operation S403. Then, the process goes to Operation S405.

In Operation S405, the parallelizing compiler 70 sets the value of a variable i at 1. Then, the process goes to Operation S406.

In Operation S406, the parallelizing compiler 70 extracts a grouping target graph Gbi from the graph Gb. Then, the process goes to Operation S407.

In Operation S407, the parallelizing compiler 70 determines whether the grouping target graph Gbi extracted in Operation S406 is empty or not. When the grouping target graph Gbi is empty, the process goes to Operation S402. On the other hand, when the grouping target graph Gbi is not empty, the process goes to Operation S408.

In Operation S408, the parallelizing compiler 70 sets a graph, obtained by removing the grouping target graph Gbi from the graph Gb, as a graph Gb. Then, the process goes to Operation S409.

In Operation S409, the parallelizing compiler 70 increments the variable i. Then, the process goes to Operation S410.

In Operation S410, the parallelizing compiler 70 determines whether or not the variable i is greater than a given value m, for example, the number of process groups of a data transfer suppression target to be executed contemporaneously. When the variable i is greater than the given value m, the process goes to Operation S402. On the other hand, when the variable i is equal to or smaller than the given value m, the process goes to Operation S406.

There are provided m entry nodes for which scheduling rules are changed. There is provided a single entry node for which no scheduling rule is changed, and the number of the entry nodes becomes (m+1). A single distribution node is provided. Dispatch nodes are provided in accordance with the number of processor cores of the processor system 10; for example, n dispatch nodes are provided. When the number of processor cores of the processor system 10 is not determined, the number of dispatch nodes is set at the maximum parallelism inherent in the sequential program 71. The n dispatch nodes are associated with the n processor cores on a one-to-one basis.

A process group corresponding to a vertex set of a grouping target graph, e.g., a process group of a data transfer suppression target, is sequentially associated with the m entry nodes for which scheduling rules are changed. A process, which does not belong to any process group of data transfer suppression target, is associated with the single entry node for which no scheduling rule is changed. All the entry nodes are coupled to the single distribution node. The single distribution node is coupled to all the dispatch nodes.

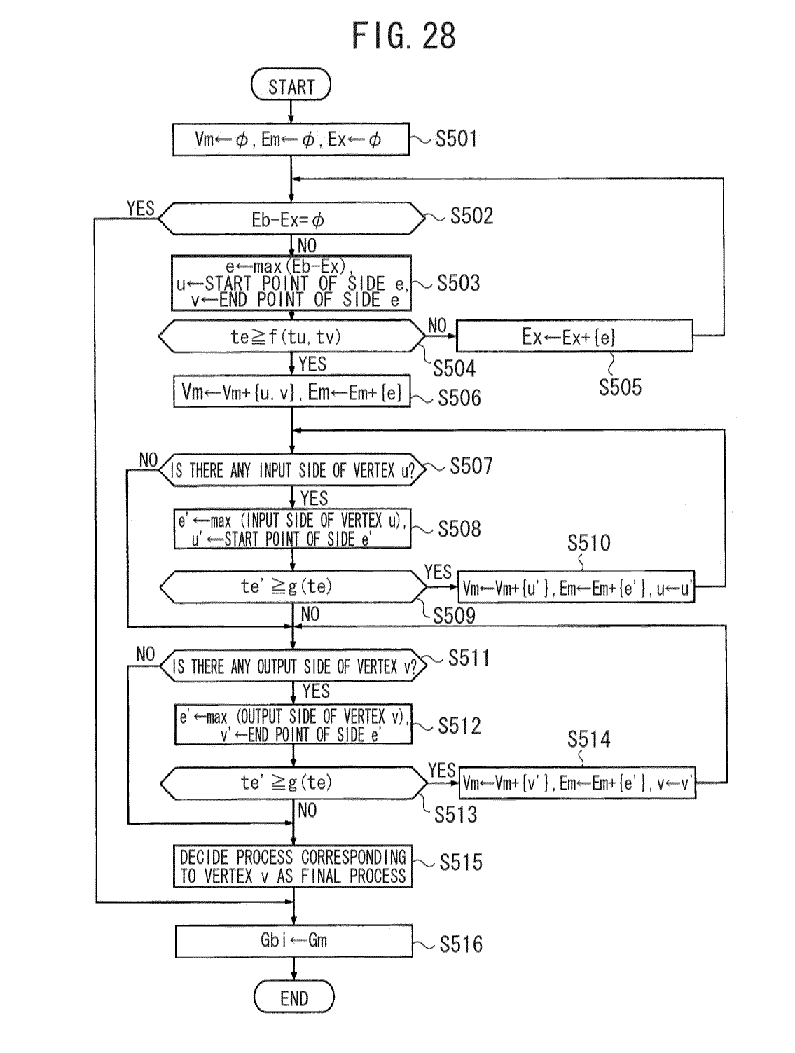

FIG. 28 illustrates an exemplary grouping target graph extraction process. For example, in Operation S406 illustrated in FIG. 27, the parallelizing compiler 70 is operated as illustrated in FIG. 28.

In Operation S501, the parallelizing compiler 70 sets a vertex set Win, a side set Em, and a side set Ex of a graph Gm at “empty”. Then, the process goes to Operation S502.

In Operation S502, the parallelizing compiler 70 determines whether there is any side included in a side set Eb of the data flow graph of the basic block selected in Operation S403 of FIG. 27 but not included in the side set Ex. When there is no side which is included in the side set Eb and is not included in the side set Ex, the process goes to Operation S516. On the other hand, when there is a side included in the side set Eb but not included in the side set Ex, the process goes to Operation S503.

In Operation S503, among the sides included in the side set Eb but not included in the side set Ex, the parallelizing compiler 70 sets, as a side e, the side with a certain data transfer time, for example, the maximum data transfer time, for a pair of processes corresponding to the start point and end point of the side which are estimated in Operation S304 in FIG. 25. The parallelizing compiler 70 sets the start point of the side e as a vertex u, and sets the end point of the side e as a vertex v. Then, the process goes to Operation S504.

In Operation S504, the parallelizing compiler 70 determines whether a data transfer time te of the side e is equal to or greater than a lower limit value f (tu, tv) or not. The lower limit value f (tu, tv) is used to determine whether a pair of processes is decided as a process group of a data transfer suppression target. The lower limit value f (tu, tv) is derived based on the execution time tu and execution time tv for the vertexes u and v, for example, the process execution time corresponding to the vertexes u and v which is estimated in Operation S302 of FIG. 25. For example, as the lower limit value f (tu, tv), the product of a total of the execution time tu for the vertex u and the execution time tv for the vertex v, and a constant of less than 1.0 is used. When the data transfer time te of the side e is equal to or greater than the lower limit value f (tu, tv), the process goes to Operation S506. On the other hand, when the data transfer time te of the side e is less than the lower limit value f (tu, tv), the process goes to Operation S505.

In Operation S505, the parallelizing compiler 70 adds the side e to the side set Ex. Then, the process goes to Operation S502.

In Operation S506, the parallelizing compiler 70 adds the vertexes u and v to the vertex set Win, and adds the side e to the side set Em. Then, the process goes to Operation S507.

In Operation S507, the parallelizing compiler 70 determines whether there is any input side of the vertex u or not. When there is an input side of the vertex u, the process goes to Operation S508. On the other hand, when there is no input side of the vertex u, the process goes to Operation S511.

In Operation S508, among the input sides of the vertex u, the parallelizing compiler 70 sets, as a side e′, the side with the maximum data transfer time, and sets the start point of the side e′ as a vertex u′. Then, the process goes to Operation S509.

In Operation S509, the parallelizing compiler 70 determines whether data transfer time te′ of the side e′ is equal to or greater than a lower limit value g (te) or not. The lower limit value g (te) is used to determine whether a process is added to a process group of a data transfer suppression target. The lower limit value g (te) is derived based on the data transfer time te of the side e. For example, as the lower limit value g (te), the product of the data transfer time te of the side e and a constant of less than 1.0 is used. When the data transfer time te′ of the side e′ is equal to or greater than the lower limit value g (te), the process goes to Operation S510. On the other hand, when the data transfer time te′ of the side e′ is less than the lower limit value g (te), the process goes to Operation S511.

In Operation S510, the parallelizing compiler 70 adds the vertex u′ to the vertex set Win, adds the side e′ to the side set Em, and sets the vertex u′ as the vertex u. Then, the process goes to Operation S507.

In Operation S511, the parallelizing compiler 70 determines whether there is any output side of the vertex v or not. When there is an output side of the vertex v, the process goes to Operation S512. On the other hand, when there is no output side of the vertex v, the process goes to Operation S515.

In Operation S512, among the output sides of the vertex v, the parallelizing compiler 70 sets, as a side e′, the side with the maximum data transfer time, and sets the end point of the side e′ as a vertex v′. Then, the process goes to Operation S513.

In Operation S513, the parallelizing compiler 70 determines whether the data transfer time te′ of the side e′ is equal to or greater than the lower limit value g (te) or not. When the data transfer time te′ of the side e′ is equal to or greater than the lower limit value g (te), the process goes to Operation S514. On the other hand, when the data transfer time te′ of the side e′ is less than the lower limit value g (te), the process goes to Operation S515.

In Operation S514, the parallelizing compiler 70 adds the vertex v′ to the vertex set Vm, adds the side e′ to the side set Em, and sets the vertex v′ as the vertex v. Then, the process goes to Operation S511.

In Operation S515, the parallelizing compiler 70 decides the process corresponding to the vertex v as the final process of the process group of a data transfer suppression target, for example, the process group corresponding to the vertex set Vm. Then, the process goes to Operation S516.

In Operation S516, the parallelizing compiler 70 sets the graph Gm as the grouping target graph Gbi. Then, the grouping target graph extraction process is ended, and the process goes to Operation S407 illustrated in FIG. 27.

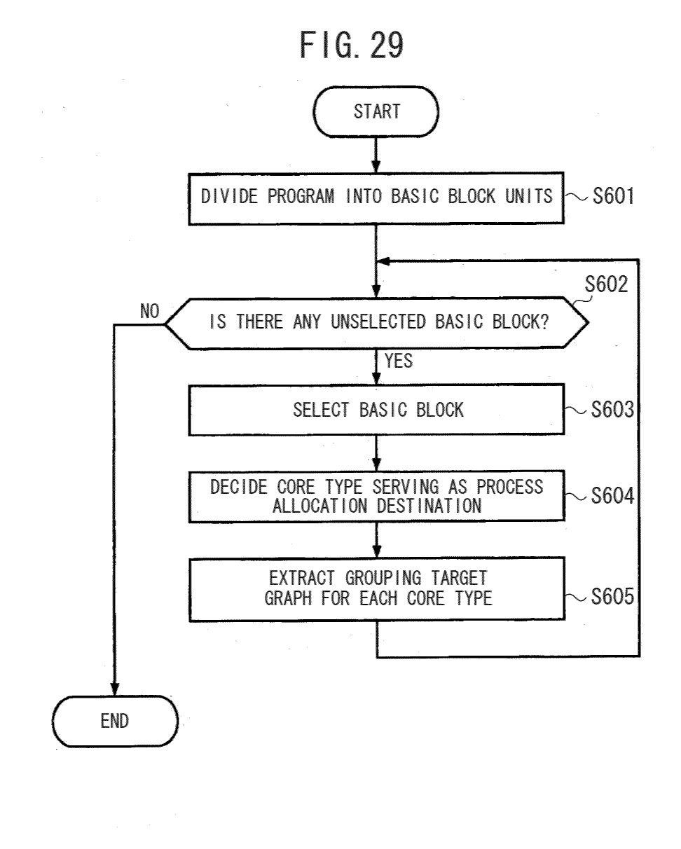

FIG. 29 illustrates an exemplary scheduling policy optimization process. When the system configuration of the processor system 10, including the number of processor cores and the type of each processor core, for example, is determined, the parallelizing compiler 70 may allow the scheduler setting information 72 to be generated in accordance with the system configuration. The operation flow of the parallelizing compiler 70 may be substantially similar to that illustrated in FIG. 25. However, Operations S302 and S305 in this example may differ from those of the operation flow illustrated in FIG. 25.

In Operation S302, for the plurality of processes obtained in Operation S301, the parallelizing compiler 70 estimates execution time of each process for each core type, e.g., for each processor core type. For example, the parallelizing compiler 70 may estimate process execution time from the Million Instructions Per Second (MIPS) rate or the like of the processor core by estimating the number of instructions based on the number of program lines, loop counts, etc. The parallelizing compiler 70 may use execution time for each process which is given from a user based on past records, experience, etc.

In Operation S305, the parallelizing compiler 70 carries out the scheduling policy optimization process illustrated in FIG. 29, based on analysis of the control-dependent relationship and data-dependent relationship between processes, which are obtained in Operations S302 to S304, for example, based on a control flow graph and a data flow graph, and an estimation of execution time for each process and data transfer time for each pair of processes having a data-dependent relationship.

In Operation S601, the parallelizing compiler 70 divides the sequential program 71 into basic block units based on the control flow graph (CFG). Then, the process goes to Operation S602.

In Operation S602, for a plurality of basic blocks obtained in Operation S601, the parallelizing compiler 70 determines whether there is any unselected basic block or not. When there is an unselected basic block, the process goes to Operation S603. On the other hand, when there is no unselected basic block, the scheduling policy optimization process is ended, and the process goes to Operation S306 illustrated in FIG. 25.

In Operation S603, the parallelizing compiler 70 selects one of the unselected basic blocks. Then, the process goes to Operation S604.

In Operation S604, for the basic block selected in Operation S603, the parallelizing compiler 70 decides a core type of an allocation destination for each process. Then, the process goes to Operation S605.

In Operation S604, the core type of a process allocation destination may be decided based on a user's instruction by a pragma or the like, for example. The core type of a process allocation destination may be decided so that the core type is suitable for process execution and the load between processor cores is balanced. For a certain process, the core type of an allocation destination may be decided by comparing performance ratio such as execution time estimated for each core type. To a process for which the core type of an allocation destination is not decided and which shares a large amount of data with a process for which the core type of an allocation destination is decided, the same core type as that of the latter process may be allocated. For the remaining processes, the core types of an allocation destination may be decided so that the load between core types is not unbalanced. For example, a series of core type allocations to the remaining processes may be performed, the value obtained by dividing a total sum of process execution time for each core type decided as the allocation destination by the number of processor cores of the core type may be calculated, and then the core type allocation, which minimizes unbalance of process execution time between core types, may be selected. The core type of an allocation destination may be decided so that the unbalance of the load between core types is eliminated in sequence from the process whose execution time is longest among the remaining processes.

In Operation S605, the parallelizing compiler 70 may carry out the grouping target graph extraction process illustrated in FIG. 28 for each core type, based on the core type of an allocation destination for each process which has been decided in Operation S604. Then, the process goes to Operation S602.

For each core type, when the number of process groups of a data transfer suppression target executed contemporaneously is m', m' entry nodes, for which scheduling rules are changed, and a single entry node, for which no scheduling rule is changed, are provided. The number of process groups, of a data transfer suppression target executed contemporaneously, may be given by a pragma or the like from a user. A single distribution node is provided for each core type. Dispatch nodes are provided in accordance with the number of processor cores of the processor system 10; for example, n dispatch nodes are provided. The n dispatch nodes are associated with the n processor cores on a one-to-one basis.

For each core type, a process group corresponding to a vertex set of a grouping target graph, for example, a process group of a data transfer suppression target, is sequentially associated with the m′ entry nodes for which scheduling rules are changed. A process, which does not belong to any process group of a data transfer suppression target, is associated with the single entry node for which no scheduling rule is changed. For each core type, all the entry nodes are coupled to the single distribution node. For each core type, the single distribution node is coupled to all the dispatch nodes.

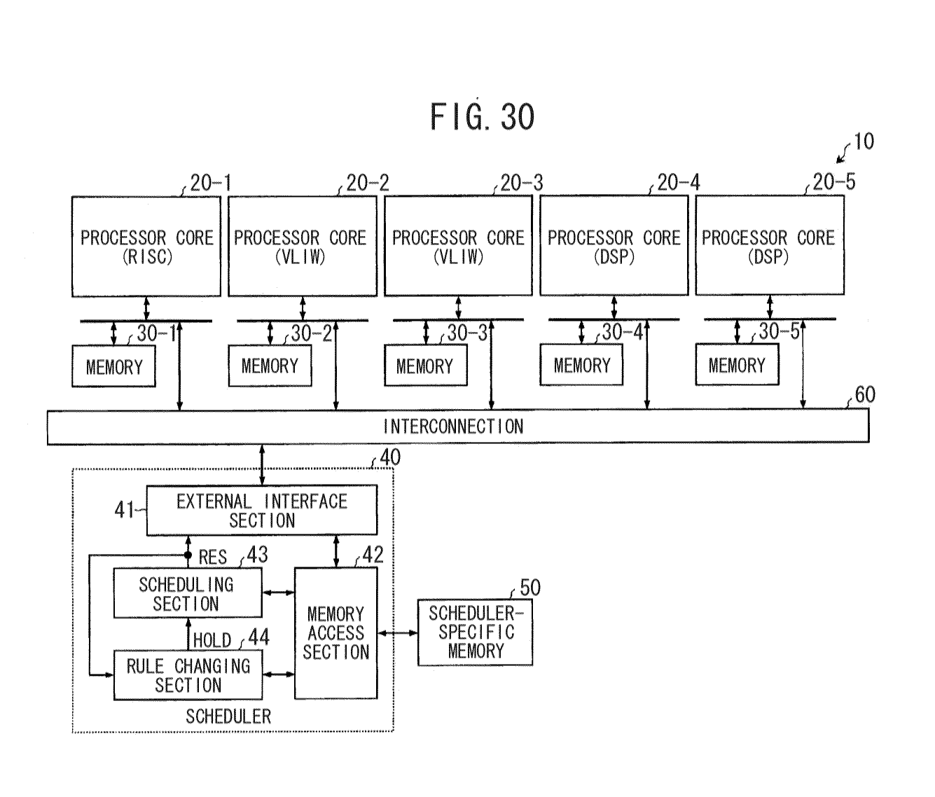

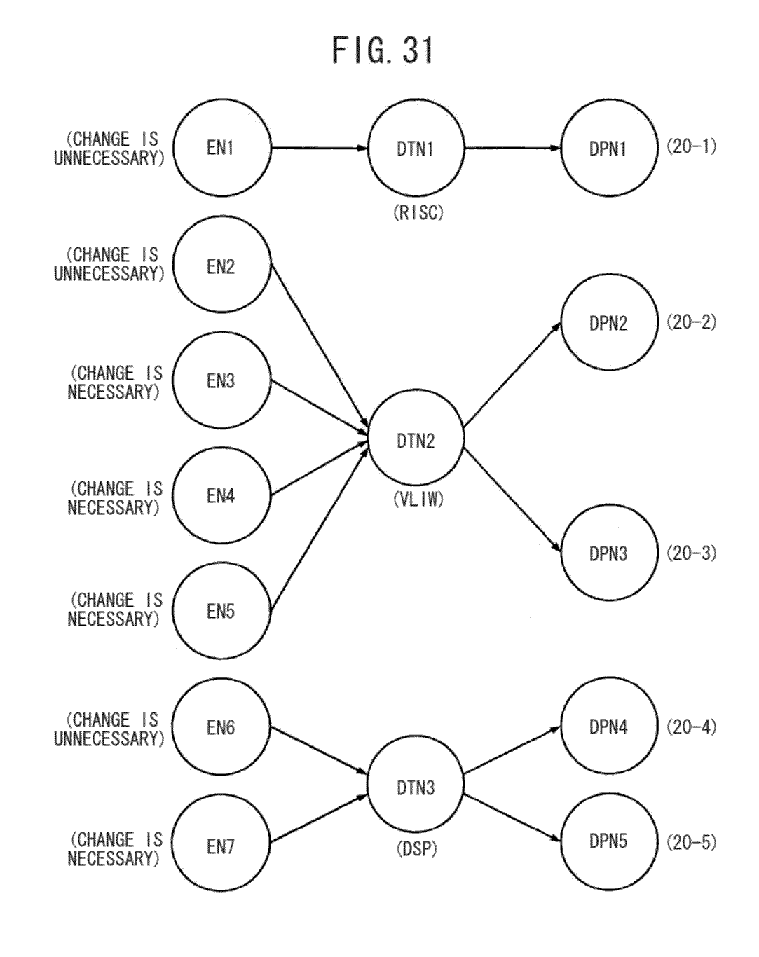

FIG. 30 illustrates an exemplary processor system. The processor system may be the processor system illustrated in FIG. 1. FIG. 31 illustrates exemplary scheduling rules. The scheduling rules may be scheduling rules for the processor system illustrated in FIG. 1. For example, the processor system 10 illustrated in FIG. 30 includes five memories, a RISC processor core 20-1, VLIW processor cores 20-2 and 20-3, and DSP processor cores 20-4 and 20-5. For example, the number of process groups of a data transfer suppression target executed contemporaneously in the VLIW processor cores 20-2 and 20-3 is three, and the number of process groups of a data transfer suppression target executed contemporaneously in the DSP processor cores 20-4 and 20-5 is one. The scheduler setting information 72 generated by the parallelizing compiler 70 in accordance with the system configuration of the processor system 10 may specify the scheduling rules illustrated in FIG. 31.

In the scheduling rules illustrated in FIG. 31, concerning the RISC processor core, there are provided: a single entry node EN1 for which the scheduling rule is changed; a single distribution node DTN1; and a single dispatch node DPN1 associated with the processor core 20-1. The entry node EN1 is coupled to the distribution node DTN1, and the distribution node DTN1 is coupled to the dispatch node DPN1.

Concerning the VLIW processor cores, there are provided: a single entry node EN2 for which the scheduling rule is changed; three entry nodes EN3, EN4 and EN5 for which the scheduling rules are not changed; a single distribution node DTN2; and two dispatch nodes DPN2 and DPN3 associated with the processor cores 20-2 and 20-3, respectively. All the entry nodes EN2 to EN5 are coupled to the distribution node DTN2, and the distribution node DTN2 is coupled to both of the dispatch nodes DPN2 and DPN3.

Concerning the DSP processor cores, there are provided: a single entry node EN6 for which the scheduling rule is changed; a single entry node EN7 for which no scheduling rule is changed; a single distribution node DTN3; and two dispatch nodes DPN4 and DPN5 associated with the processor cores 20-4 and 20-5, respectively. Both of the entry nodes EN6 and EN7 are coupled to the distribution node DTN3, and the distribution node DTN3 is coupled to both of the dispatch nodes DPN4 and DPN5.

According to the foregoing embodiment, in the scheduler 40 of the distributed memory type multicore processor system 10, the scheduling section 43 decides an allocation destination for the first process of the process group of a data transfer suppression target. The rule changing section 44 changes the scheduling rules so that the scheduling section 43 allocates the subsequent process of the process group, of a data transfer suppression target, to the same processor core as that to which the first process has been allocated. When the scheduling section 43 decides the allocation destination for the final process of the process group of a data transfer suppression target, the rule changing section 44 restores the scheduling rules. Thus, the dynamic load is distributed, and the data transfer between processor cores is reduced, thereby enhancing software execution efficiency. The parallelizing compiler 70 sets the scheduler setting information 72, thus shortening the program development period, and cutting down on the cost of the processor system 10.

Example embodiments of the present invention have now been described in accordance with the above advantages. It will be appreciated that these examples are merely illustrative of the invention. Many variations and modifications will be apparent to those skilled in the art.

1. A scheduler for conducting scheduling for a processor system including a plurality of processor cores and a plurality of memories respectively corresponding to the plurality of processor cores, the scheduler comprising:
a scheduling section that allocates one of the plurality of processor cores to one of a plurality of process requests corresponding to a process group based on rule information; and
a rule changing section that, when a first processor core is allocated to a first process of the process group, changes the rule information and allocates the first processor core to a subsequent process of the process group, and that restores the rule information when a second processor core is allocated to a final process of the process group.

2. The scheduler according to claim 1,
wherein the rule information includes allocation information between a plurality of entry nodes which receive the process request and the plurality of processor cores,
wherein the plurality of entry nodes includes a first entry node for which the rule information is changed, and a second entry node for which the rule information is not changed, and
wherein the rule changing section recognizes, as a process of the process group, a process whose process request is input to the second entry node.

3. The scheduler according to claim 2,
wherein the scheduler uses control information,
wherein the control information includes the rule information, first flag information that is set at a set state when each of the plurality of entry nodes is the second entry node, and second flag information that is set at a set state when the rule information of the entry node is changed, and
wherein the rule changing section determines whether or not the rule information is changed based on the first flag information and the second flag information of the entry node which receives the process request when the scheduling section performs an allocation.

4. The scheduler according to claim 3,
wherein the rule changing section identifies, based on scheduling information output from the scheduling section, a process allocated by the scheduling section, and the rule changing section changes the rule information and sets the second flag information in the set state when the first flag information of the entry node which receives the process request is in the set state and the second flag information is in a reset state.

5. The scheduler according to claim 3,
wherein the control information further includes third flag information that is set in a set state when a process is the final process of the process group, and wherein the rule changing section determines whether or not the rule information is restored based on the first flag information, the second flag information, and the third flag information of the entry node which receives the process request when the scheduling section performs the allocation.

6. The scheduler according to claim 5,
wherein the rule changing section identifies a process not to be allocated by the scheduling section based on scheduling information output from the scheduling section, and the rule changing section restores the rule information and sets the second flag information in the reset state when the first flag information, the second flag information, and the third flag information of the entry node which receives the process request are in the set state.

7. A processor system comprising:
a plurality of processor cores;
a plurality of memories respectively corresponding to the plurality of processor cores; and
a scheduler that conducts scheduling for the plurality of processor cores, the scheduler comprising:
a scheduling section that allocates one of the plurality of processor cores to one of a plurality of process requests corresponding to a process group based on rule information; and
a rule changing section that, when a first processor core is allocated to a first process of the process group, changes the rule information and allocates the first processor core to a subsequent process of the process group, and that restores the rule information when a second processor core is allocated to a final process of the process group.

8. The processor system according to claim 7,
wherein the rule information includes allocation information between a plurality of entry nodes which receive the process request and the plurality of processor cores,
wherein the plurality of entry nodes includes a first entry node for which the rule information is changed and a second entry node for which the rule information is not changed, and
wherein the rule changing section recognizes, as a process of the process group, a process whose process request is input to the second entry node.

9. The processor system according to claim 8,
wherein the scheduler uses control information,
wherein the control information includes the rule information, first flag information that is set at a set state when each of the plurality of entry nodes is the second entry node, and second flag information that is set at a set state when the rule information of the entry node is changed, and
wherein the rule changing section determines whether or not the rule information is changed based on the first flag information and the second flag information of the entry node which receives the process request when the scheduling section performs an allocation.

10. The processor system according to claim 9,
wherein the rule changing section identifies, based on scheduling information output from the scheduling section, a process on which an allocation has been performed by the scheduling section, and when the first flag information concerning the entry node to which an execution request for the process has been input is in a set state while the second flag information is in a reset state, the rule changing section changes the rule information and sets the second flag information to the set state when the first flag information of the entry node which receives the process request is in the set state and the second flag information is in a reset state.

11. The processor system according to claim 9,
wherein the control information further includes third flag information that is set in a set state when a process is the final process of the process group, and
wherein the rule changing section determines whether or not the rule information is restored based on the first flag information, the second flag information, and the third flag information of the entry node which receives the process request when the scheduling section performs the allocation.

12. The processor system according to claim 11,
wherein the rule changing section identifies a process not to be allocated by the scheduling section based on scheduling information output from the scheduling section, and the rule changing section restores the rule information and sets the second flag information to the reset state when the first flag information, the second flag information, and the third flag information of the entry node which receives the process request are in the set state.

13. A program generation method for generating a program stored in a computer-readable medium for a processor system including a plurality of processor cores, a plurality of memories respectively corresponding to the plurality of processor cores, and a scheduler that schedules for the plurality of processor cores, the method comprising:
reading a program to divide the program into a plurality of processes;
estimating an execution time for each process among the plurality of processes;
estimating a data transfer time for a pair of processes having a data-dependent relationship based on a control-dependent relationship and a data-dependent relationship between the processes;
deciding among the plurality of processes, a process group based the control-dependent relationship, data-dependent relationship, the estimated execution time, and the estimated data transfer time; and
generating the program and scheduler setting information,
wherein the same processor core is allocated to the process group based on the scheduler setting information.

14. The program generation method according to claim 13,
wherein the plurality of processor cores includes a plurality of types of processor cores,
wherein the execution time for each process is estimated for each type of the processor cores, and
wherein the process group is decided for each processor core type.
